(19) United States
(12) Patent Application Publication
(10) Pub. No.: US 2026/0341661 A1
(43) Pub. Date: Oct. 29, 2026

(54) CHEMICAL IONISATION ION SOURCE AND CHEMICAL IONISATION METHOD

(71) Applicant: TOFWERK AG, Thun (CH)

(72) Inventors: Vasyl YATSYNA, Thun (CH); Felipe LOPEZ-HILFIKER, Steffisburg (CH); Urs ROHNER, Thun (CH)

(73) Assignee: TOFWERK AG, Thun (CH)

(21) Appl. No.: 19/656,323

(22) Filed: Apr. 23, 2026

(30) Foreign Application Priority Data
Apr. 24, 2025 (EP) 25172367.2

(51) Int. Cl. H01J 49/14; H01J 49/24

(52) U.S. Cl. CPC H01J 49/145; H01J 49/24

(57) ABSTRACT

The invention relates to a chemical ionisation ion source (1), in particular for a mass spectrometer (100), for ionising an analyte in a sample by chemical ionisation to analyte ions. The chemical ionisation ion source (1) includes an irradiation chamber (2) forming an irradiation chamber volume (21) and having a reagent inlet (22) for inserting a reagent comprising reagent molecules and/or reagent atoms into said irradiation chamber volume (21); a photoelectron emittance surface (24) included in said irradiation chamber (2) for emitting in said irradiation chamber volume (21) photoelectrons from said photoelectron emittance surface (24) when said photoelectron emittance surface (24) is irradiated with electromagnetic radiation, in particular ultraviolet light; an electromagnetic radiation source, in particular an ultraviolet light source (5), adapted to illuminate said photoelectron emittance surface (24) with electromagnetic radiation, in particular ultraviolet light, for emitting photoelectrons from said photoelectron emittance surface (24); a reaction chamber (3) confining a reaction chamber volume (31) and having a sample inlet (32) for inserting the sample comprising the analyte into said reaction chamber volume (31) for ionising the analyte to the analyte ions in said reaction chamber volume (31) by bringing the analyte into contact with reagent ions being ionised reagent molecules and/or reagent atoms, respectively, wherein said reaction chamber (3) further has an outlet (33) for letting the analyte ions out of said reaction chamber volume (31); a chamber interface (4) adapted to fluidly couple said irradiation chamber volume (21) to said reaction chamber volume (31) for transferring a gaseous content of said irradiation chamber volume (21) from said irradiation chamber volume (21) to said reaction chamber volume (31); a collector electrode (6), wherein said collector electrode (6) is arranged in said reaction chamber (3) in vicinity of said chamber interface (4), is arranged at said chamber interface (4) or forms said chamber interface (4); a collector voltage source (7) connected to at least one of said photoelectron emittance surface (24) and said collector electrode (6) and for applying a voltage difference between said photoelectron emittance surface (24) and said collector electrode (6) such that a potential of said collector electrode (24) is higher than a potential of said photoelectron emittance surface (24) in order to drive negative charges from said photoelectron emittance surface (24) towards said collector electrode (6); and a control unit (8) adapted to control said collector voltage source (7) to apply the voltage difference between said photoelectron emittance surface (24) and said collector electrode (6) such that the potential of said collector electrode (6) is higher than the potential of said photoelectron emittance surface (24) in order to drive negative charges from said photoelectron emittance surface (24) towards said collector electrode (6). The invention further relates to a chemical ionisation method, in particular for mass spectrometry, for ionising an analyte in a sample by chemical ionisation to analyte ions with a chemical ionisation ion source, in particular with the chemical ionisation ion source (1) according to the invention.

### TECHNICAL FIELD

The invention relates to a chemical ionisation ion source, in particular for a mass spectrometer, for ionising an analyte in a sample by chemical ionisation to analyte ions. Furthermore, the invention relates to a chemical ionisation method, in particular for mass spectrometry, for ionising an analyte in a sample by chemical ionisation to analyte ions with a chemical ionisation ion source, in particular with the chemical ionisation ion source according to the invention.

### BACKGROUND ART

In chemical ionisation, ionised analytes are produced in a reaction chamber through collisions of the analytes with reagent ions. These reagent ions are sometimes also referred to as primary ions. The reagent ions can be created from a reagent being in a solid, liquid or gaseous aggregate state. Thereby, the reagent can be ionised for example by electron ionisation, electromagnetic radiation like x-rays or UV radiation, or radioactive radiation to the reagent ions.

Chemical ionisation is known as a soft and gentle ionisation technique for generating analyte ions from a sample. In chemical ionisation, the analyte molecules of the sample react with the reagent ions which transfer their charge to the analyte molecules, thus ionising the analyte molecules to analyte ions. These analyte ions can then be mass-analysed with a mass analyser as known in the art.

The gentle ionisation of the analyte molecules in chemical ionisation is performed in at least two steps. In a first step, reagent ions are formed from a reagent. The reagent ions may be generated under harsh conditions. In the final step, the reagent ions are reacted with analyte molecules of the sample. These analyte molecules are in most cases neutral. When the reagent ions react with the analyte molecules, the charge of the reagent ions is transferred to the analyte molecules such that from the analyte molecules, analyte ions are formed. This latter final step is the chemical ionisation reaction used in chemical ionisation for ionising the analyte molecules to the analyte ions. Between the first step and the final step, there are further steps possible. In one example of such a further step, the further step is another charge transfer step, transferring the charge from primary reagent ions to secondary reagent ions with a lower energy, allowing for a softer ionisation of the secondary reagent to secondary reagent ions, wherein ultimately, the secondary reagent ions are reacted with the analyte molecules of the sample, transferring the charge of the secondary reagent ions to the analyte molecules in order to form the analyte ions. Therefore, different ionisation methods for obtaining the reagent ions are possible, based on e.g., corona discharge, plasma discharge, barrier discharge, electromagnetic radiation, electrospray ionisation (ESI), electron ionization (EI), electron attachment ionization, or radiation due to radioactive decay.

Common chemical ionisation reactions used in chemical ionisation ion sources comprise protonation, deprotonation, adduct formation with the reagent ion or a fragment thereof, or electron attachment or detachment. Such processes are governed by the balance of the gas phase basicity (proton affinity), the balance of the ionisation potential, the electron affinity, the dipole moment, or the binding energy of the reagent ions to the analyte molecules.

In chemical ionisation, a direct interaction of the reagent ions with the analyte molecules occurs. Thereby, in a reaction volume, the reagent ions, the analyte and the analyte ions undergo low energetic collisions such that the molecular structure of the analyte is mainly maintained and rearrangement or fragmentation of the analyte while being ionised to the analyte ions are avoided to a large extent. Since the reaction volume is generally confined by a reaction chamber, the reaction volume is sometimes as well referred to as reaction chamber volume.

For these reasons, chemical ionisation has emerged as a core analytical tool for the analysis of primarily volatile organic chemicals in atmospheric chemistry and related fields (e.g., soil emissions, medical and food sciences, air quality monitoring) which require molecular-level speciation.

One example of a chemical ionisation ion source is described in CN 109841491 A. This chemical ionisation ion source comprises a closed chamber forming a chamber volume. In the closed chamber, a grid electrode is arranged, dividing the chamber volume into a photoionisation region and a chemical ionisation region. Furthermore, an ion repeller electrode is arranged inside the photoionisation region at a side opposite the chemical ionisation region. Thereby, the ion repeller electrode and the grid electrode are arranged spaced, opposite and parallel to each other. Furthermore, an ultraviolet light source is provided for illuminating at least parts of the photoionisation region with ultraviolet light.

In operation of this chemical ionisation ion source, the sample including the analyte to be ionised to analyte ions is inserted into the chemical ionisation region. Furthermore, a gaseous reagent consisting of reagent molecules is inserted into the photoionisation region through a reagent tube. In the photoionisation region, photoelectrons are generated by the ultraviolet light illuminating an electrode. These photoelectrons ionise the reagent molecules ionised to reagent ions by photoelectron ionisation. The resulting reagent ions are then transferred to the chemical ionisation region. There, they react with the analyte of the sample with ion-molecule reactions, causing chemical ionisation of the analyte to the analyte ions. Thereby, different DC voltages and radio frequency voltages are applied to metal ring electrodes in the chemical ionisation region such that the ions in the chemical ionisation region converge toward an outlet of the closed chamber and are output from the outlet.

In order to transfer the reagent ions from the photoionisation region to the chemical ionisation region, a voltage difference is applied between the ion repeller electrode and the grid electrode for generating an ion repulsion electric field in the axial direction of the ion repeller electrode and the grid electrode. Thus, due to the drive of the ion repulsion voltage, the reagent ions generated in the photoionisation region pass through the grid electrode and enter the chemical ionisation region.

In this setup, photoelectrons generated in the photoionisation region are accelerated to the ion repeller electrode and thus away from the grid electrode. Consequently, such known chemical ionisation ion sources provide a very limited space where the photoelectron ionisation of the reagent molecules to the reagent ions can occur. Furthermore, in such known chemical ionisation ion sources, the grid electrode allows analyte ions to move from the chemical ionisation region to the photoionisation region. There, photochemically induced rearrangements of the analyte can occur. Therefore, the ionisation processes in such chemical ionisation ion sources are undefined.

As a result of these effects, the known chemical ionisation ion sources have the disadvantage that they only provide an insufficient production of reagent ions and thus only allow for an inefficient chemical ionisation of the analytes to analyte ions and do not enable a well defined chemical ionisation of the analytes either.

In the present text, the term “and/or” is sometimes used for linking two features. For example this term is used to link the features A and B in the formulation “A and/or B”. Such a formulation means that at least feature A or feature B is realized. In other words, the formulation includes the option of “A and not B”, the option “B and not A”, as well as the option “A and B”.

### DISCLOSURE OF THE INVENTION

The object of the invention is to provide a chemical ionisation ion source and a chemical ionisation method for ionising an analyte in a sample by chemical ionisation to analyte ions which enables a more efficient and better defined chemical ionisation of the analyte to analyte ions.

The solution to the object of the invention is defined by the features of claim 1. According to the invention, the chemical ionisation ion source includes an irradiation chamber forming an irradiation chamber volume and having a reagent inlet for inserting a reagent comprising reagent molecules and/or reagent atoms into the irradiation chamber volume. Furthermore, the chemical ionisation ion source includes a photoelectron emittance surface included in the irradiation chamber for emitting in the irradiation chamber volume photoelectrons from the photoelectron emittance surface when the photoelectron emittance surface is irradiated with electromagnetic radiation, in particular ultraviolet light. The chemical ionisation ion source further includes an electromagnetic radiation source, in particular an ultraviolet light source, adapted to illuminate the photoelectron emittance surface with electromagnetic radiation, in particular ultraviolet light, for emitting photoelectrons from the photoelectron emittance surface. The chemical ionisation ion source further includes a reaction chamber confining a reaction chamber volume and having a sample inlet for inserting the sample comprising the analyte into the reaction chamber volume for ionising the analyte to the analyte ions in the reaction chamber volume by bringing the analyte into contact with reagent ions being ionised reagent molecules and/or reagent atoms, respectively, wherein the reaction chamber further has an outlet for letting the analyte ions out of the reaction chamber volume. The chemical ionisation ion source further includes a chamber interface adapted to fluidly couple the irradiation chamber volume to the reaction chamber volume for transferring a gaseous content of the irradiation chamber volume, in particular gas, ions and electrons and thus reagent molecules and/or reagent atoms, respectively, reagent ions and electrons like for example photoelectrons, from the irradiation chamber volume to the reaction chamber volume. The chemical ionisation ion source further includes a collector electrode. This collector electrode is arranged in the reaction chamber in vicinity of the chamber interface, is arranged at the chamber interface or forms the chamber interface. The chemical ionisation ion source further includes a collector voltage source connected to at least one of the photoelectron emittance surface and the collector electrode and for applying a voltage difference, in particular a DC voltage difference, between the photoelectron emittance surface and the collector electrode such that a potential of the collector electrode is higher than a potential of the photoelectron emittance surface in order to drive negative charges from the photoelectron emittance surface towards the collector electrode. Furthermore, the chemical ionisation ion source includes a control unit adapted to control the collector voltage source to apply the voltage difference between the photoelectron emittance surface and the collector electrode such that the potential of the collector electrode is higher than the potential of the photoelectron emittance surface in order to drive negative charges from the photoelectron emittance surface towards the collector electrode.

As mentioned, the chemical ionisation ion source includes an electromagnetic radiation source, in particular an ultraviolet light source, adapted to illuminate the photoelectron emittance surface with electromagnetic radiation, in particular ultraviolet light, for emitting photoelectrons from the photoelectron emittance surface. This electromagnetic radiation source can for example be an ultraviolet light source adapted to illuminate the photoelectron emittance source with ultraviolet light for emitting photoelectrons from the photoelectron emittance surface or can for example be an X-ray source adapted to illuminate the photoelectron emittance source with X-ray radiation for emitting photoelectrons from the photoelectron emittance surface. This electromagnetic radiation source can be arranged inside the irradiation chamber volume or can be arranged outside of the irradiation chamber volume. In the first case, the electromagnetic radiation source is part of the irradiation chamber and can for example be arranged to irradiate electromagnetic radiation directly onto the photoelectron emittance surface for emitting photoelectrons from the photoelectron emittance surface. In the second case, the electromagnetic radiation source can for example be part of the irradiation chamber or can be separate from the irradiation chamber. Thereby, for example, the electromagnetic radiation source can be arranged in a volume adjacent to the volume of the irradiation chamber, wherein the two volumes are separated by a window transparent for the electromagnetic radiation emitted by the electromagnetic radiation source. In this case, ultraviolet light can be directed from the electromagnetic radiation source through the window onto the photoelectron emittance surface for emitting photoelectrons from the photoelectron emittance surface.

As mentioned, the chemical ionisation ion source includes a collector electrode, wherein the collector electrode is arranged in the reaction chamber in vicinity of the chamber interface, is arranged at the chamber interface or forms the chamber interface. In case the collector electrode is arranged in the reaction chamber in vicinity of the chamber interface, the collector electrode can be located at the chamber interface or can be located separately from the chamber interface. In case the collector electrode is arranged at the chamber interface, the collector electrode can be arranged at the chamber interface in the reaction chamber, fully or partially in the reaction chamber volume or in the reaction chamber but outside the reaction chamber volume, in the irradiation chamber volume, or inside the chamber interface and thus separated from the reaction chamber volume and the irradiation chamber volume. In the latter case, where the collector electrode is arranged inside the chamber interface, the collector electrode can be covered by the chamber interface, can provide a surface which contacts the reaction chamber volume, can provide a surface which contacts the irradiation chamber volume or can provide a surface which contacts the reaction chamber volume as well as a surface which contacts the irradiation chamber volume.

Thus, the collector electrode can be arranged in the reaction chamber by being arranged in the reaction chamber in vicinity of the chamber interface, by being arranged at the chamber interface in the reaction chamber, by being arranged fully or partially in the reaction chamber volume and by being arranged in the reaction chamber but outside the reaction chamber volume. In all these cases, the collector electrode is arranged in the reaction chamber. Thereby, the collector electrode can be part of the reaction chamber or can be separate from the reaction chamber.

Independent of where the collector electrode is arranged, the collector electrode may consist of one collector electrode element or can consist of two or more physically separated collector electrode elements. In case the collector electrodes consists of two or more physically separated collector electrode elements, each one of these two or more physically separated collector electrode elements can be arranged in the reaction chamber in vicinity of the chamber interface, can be arranged at the chamber interface or can form the chamber interface as described before for the collector electrode. For example, if the collector electrode consists of two physically separated collector electrode elements, one of the collector electrode elements can be arranged in the reaction chamber, while another one of the collector electrode elements can form the chamber interface.

As mentioned, the chemical ionisation ion source includes a collector voltage source connected to at least one of the photoelectron emittance surface and the collector electrode and for applying a voltage difference between the photoelectron emittance surface and the collector electrode such that a potential of the collector electrode is higher than a potential of the photoelectron emittance surface in order to drive negative charges from the photoelectron emittance surface towards the collector electrode.

As mentioned, the chemical ionisation ion source includes a control unit adapted to control the collector voltage source to apply the voltage difference between the photoelectron emittance surface and the collector electrode such that the potential of the collector electrode is higher than the potential of the photoelectron emittance surface in order to drive negative charges from the photoelectron emittance surface towards the collector electrode. Thereby, the control unit can be any unit which is adapted for this purpose. For example, it can be a hardwired circuitry which is adapted for this purpose. It can however as well be any unit including a processor which is programmed to control the collector voltage source to apply the voltage difference between the photoelectron emittance surface and the collector electrode such that the potential of the collector electrode is higher than the potential of the photoelectron emittance surface in order to drive negative charges from the photoelectron emittance surface towards the collector electrode. For example, the control unit can be a personal computer (PC), a tablet, a smartphone or any other computer having a software installed to control the collector voltage source to apply the voltage difference between the photoelectron emittance surface and the collector electrode such that the potential of the collector electrode is higher than the potential of the photoelectron emittance surface in order to drive negative charges from the photoelectron emittance surface towards the collector electrode.

In case the collector voltage source is connected to the collector electrode for applying the voltage difference between the photoelectron emittance surface and the collector electrode, the collector voltage source can be as well connected to the photoelectron emittance surface or can be not connected to the photoelectron emittance surface. In either case, advantageously, a positive voltage is applied to the collector electrode by the collector voltage source in order to apply the voltage difference between the photoelectron emittance surface and the collector electrode. This has the advantage that positively charged ions are repelled away from the collector electrode. Thus, the collector electrode can be used to push positively charged analyte ions in the reaction chamber volume away from the collector electrode towards the outlet for letting the positively charged analyte ions out of the reaction chamber volume. Since the collector electrode is arranged in the reaction chamber volume in vicinity of the chamber interface, is arranged at the chamber interface or forms the chamber interface, this can easily be achieved by arranging the outlet in the reaction chamber opposite to the collector electrode. This allows to push the positively charged analyte ions with the collector electrode through the reaction chamber volume to the outlet.

The solution to the object of the invention is further defined by a chemical ionisation method, in particular for mass spectrometry, for ionising an analyte in a sample by chemical ionisation to analyte ions with a chemical ionisation ion source, in particular with the chemical ionisation ion source according to the invention. The chemical ionisation method includes inserting the reagent comprising reagent molecules and/or reagent atoms through the reagent inlet of the irradiation chamber of the chemical ionisation ion source into the irradiation chamber volume of the irradiation chamber and irradiating the photoelectron emittance surface in the irradiation chamber volume with electromagnetic radiation from the electromagnetic radiation source, in particular ultraviolet light from the ultraviolet light source, of the chemical ionisation ion source for emitting photoelectrons from the photoelectron emittance surface. The chemical ionisation method further includes applying with the collector voltage source of the chemical ionisation ion source the voltage difference, in particular the DC voltage difference, between the photoelectron emittance surface and the collector electrode of the chemical ionisation ion source such that the potential of the collector electrode is higher than the potential of the photoelectron emittance surface in order to drive negative charges from the photoelectron emittance surface towards the collector electrode, wherein the chemical ionisation ion source provides the reaction chamber forming the reaction chamber volume. Thereby, the chemical ionisation ion source provides the chamber interface adapted to fluidly couple the irradiation chamber volume to the reaction chamber volume for transferring the gaseous content of the irradiation chamber volume, in particular gas, ions and electrons and thus reagent molecules and/or reagent atoms, respectively, reagent ions and electrons, like for example photoelectrons, from the irradiation chamber volume to the reaction chamber volume, wherein the collector electrode is arranged in the reaction chamber in vicinity of the chamber interface, is arranged at the chamber interface or forms the chamber interface. Thereby, the chemical ionisation method according to the invention includes inserting the sample comprising the analyte through the sample inlet of the reaction chamber into the reaction chamber volume for ionising the analyte to the analyte ions in the reaction chamber volume.

Applying with the collector voltage source of the chemical ionisation ion source the voltage difference, in particular the DC voltage difference, between the photoelectron emittance surface and the collector electrode of the chemical ionisation ion source such that the potential of the collector electrode is higher than the potential of the photoelectron emittance surface in order to drive negative charges from the photoelectron emittance surface towards the collector electrode is advantageously achieved by controlling with a control unit of the chemical ionisation ion source to control the collector voltage source to apply the voltage difference between the photoelectron emittance surface and the collector electrode such that the potential of the collector electrode is higher than the potential of the photoelectron emittance surface in order to drive negative charges from the photoelectron emittance surface towards the collector electrode.

In case the collector voltage source is connected to the collector electrode for applying the voltage difference between the photoelectron emittance surface and the collector electrode, the collector voltage source can be as well connected to the photoelectron emittance surface or can be not connected to the photoelectron emittance surface. In either case, the photoelectron emittance surface is advantageously grounded, i.e. put to ground potential.

Alternatively, the photoelectron emittance surface is not grounded and thus is kept at a floating potential. Having the photoelectron emittance surface grounded however has the advantage that in order to apply the voltage difference between the photoelectron emittance surface and the collector electrode such that the potential of the collector electrode is higher than the potential of the photoelectron emittance surface in a well controlled manner in order to drive negative charges from the photoelectron emittance surface towards the collector electrode, it is sufficient to apply a positive voltage to the collection electrode. In case thereby, the outlet in the reaction chamber is arranged opposite to the collector electrode, the positive voltage applied to the collection electrode can be used to push positively charged analyte ions in the reaction chamber volume away from the collector electrode towards the outlet for letting the positively charged analyte ions out of the reaction chamber volume.

Advantageously, the photoelectron emittance surface is a surface of a photoelectron emittance electrode. This photoelectron emittance electrode is advantageously part of the chemical ionisation ion source. Consequently, the collector voltage source is advantageously connected to at least one of the photoelectron emittance electrode and the collector electrode for applying the voltage difference between the photoelectron emittance surface and the collector electrode such that the potential of the collector electrode is higher than the potential of the photoelectron emittance surface in order to drive negative charges from the photoelectron emittance surface towards the collector electrode.

In case the photoelectron emittance surface is a surface of a photoelectron emittance electrode and this photoelectron emittance electrode is part of the chemical ionisation ion source, the control unit is advantageously adapted to control the collector voltage source to apply the voltage difference between the photoelectron emittance electrode and the collector electrode such that the potential of the collector electrode is higher than the potential of the photoelectron emittance surface in order to drive negative charges from the photoelectron emittance surface towards the collector electrode.

As mentioned, the chemical ionisation ion source is for ionising an analyte in a sample by chemical ionisation to analyte ions while the chemical ionisation method is for ionising an analyte in a sample by chemical ionisation to analyte ions. Thereby, the sample may include only one analyte or may include more than one analytes. Even more, the sample may include many analytes. In case the sample includes more than one analyte, the chemical ionisation ion source is for ionising these analytes in the sample by chemical ionisation to analyte ions while the chemical ionisation method is for ionising these analytes in the sample by chemical ionisation to analyte ions. Thus, the singular term “analyte” used in the present text is to be understood as “at least one analyte”. It can be one analyte only or it can be two or more analytes. Often, it is actually a multiplicity of analytes. One can thus as well use the formulation that the chemical ionisation ion source is for ionising at least one analyte in a sample by chemical ionisation to analyte ions while the chemical ionisation method is for ionising at least one analyte in a sample by chemical ionisation to analyte ions.

The solution according to the invention has the advantage that due to the voltage difference between the photoelectron emittance surface and the collector electrode, photoelectrons emitted from the photoelectron emittance surface are accelerated towards the chamber interface where the collector electrode is arranged. Thus, a more efficient production of reagent ions is enabled which can be used for the chemical ionisation of the analyte. Thus, a more efficient an better defined chemical ionisation of the analyte to analyte ions is enabled.

Preferably, the chemical ionisation ion source includes a magnet for generating a magnetic field in the irradiation chamber volume. This has the advantage that the efficiency of the ionisation of the reagent to reagent ions can be increased. Advantageously, the magnet is arranged such that the magnetic field is essentially oriented along an axis from the photoelectron emittance surface to the collector electrode such that electrons, in particular photoelectrons, driven by the voltage difference between the photoelectron emittance surface and the collector electrode from the photoelectron emittance surface towards the collector electrode are driven along a spiral line towards the collector electrode. In an advantageous variant, the magnet is a magnetic focussing ring. An example of how such a magnet can be designed and arranged is described in CN 203690254 U.

Alternatively, however the chemical ionisation ion source goes without a magnet for generating a magnetic filed in the irradiation chamber volume.

Advantageously, the reagent is one or more of oxygen, water, ammonia, nitrogen, nitrogen monoxide, and argon. In case of oxygen, water, ammonia, nitrogen, nitrogen monoxide, the reagent comprises reagent molecules. In case of argon, the reagent comprises reagent atoms, advantageously, in gaseous form. Alternatively, however, the reagent can be different to oxygen, water, ammonia, nitrogen, nitrogen monoxide and argon.

Advantageously, the voltage difference between the photoelectron emittance surface and the collector electrode is between 100 V and 2000 V, particular advantageously between 400 V and 1000 V, most advantageously about 700 V. This has the advantage that the photoelectrons can be accelerated by the electrostatic field generated by the voltage difference between the photoelectron emittance surface and the collector electrode to a kinetic energy sufficient to ionise reagent molecules and/or reagent atoms, respectively, to reagent ions, thus causing photoelectron ionisation. Thereby, the photoelectron ionisation can be tuned to occur only when the photoelectron emittance surface is illuminated with the electromagnetic radiation from the electromagnetic radiation source and thus when the system is fed with photoelectrons emitted from the photoelectron emittance surface. At the same time, a self-sustaining corona discharge and a self-sustaining glow discharge can be avoided which would be sustained with the voltage difference between the photoelectron emittance surface and the collector electrode without having the photoelectron emittance surface illuminated with the electromagnetic radiation from the electromagnetic radiation source.

Alternatively, however, the voltage difference between the photoelectron emittance surface and the collector electrode can 100 V or less or can be 2000 V or more.

Advantageously, the chemical ionisation ion source is provided in combination together with the reagent. In case of such a combination of the chemical ionisation ion source and the reagent, the voltage difference between the photoelectron emittance surface and the collector electrode is advantageously such that the photoelectrons emitted from the photoelectron emittance surface are accelerated by the voltage difference between the photoelectron emittance surface and the collector electrode to a kinetic energy sufficiently high to ionise the reagent molecules and/or reagent atoms, respectively, to positively charged reagent ions and free secondary electrons. Alternatively, however, the voltage difference between the photoelectron emittance surface and the collector electrode is chosen lower such that the photoelectrons emitted from the photoelectron emittance surface are accelerated by the voltage difference between the photoelectron emittance surface and the collector electrode to a kinetic energy not sufficiently high to ionise the reagent molecules and/or reagent atoms, respectively to positively charged reagent ions and free secondary electrons. Thereby, the photoelectrons may combine with the reagent molecules and/or reagent atoms, respectively to negatively charged reagent ions. In the reaction chamber volume, these negatively charged reagent ions may release an electron. The negatively charged reagent ions can be used for the chemical ionisation of the analyte to analyte ions.

Nonetheless, the chemical ionisation ion source as well may go without the reagent. In use of such a chemical ionisation ion source, however, the reagent is used.

Independent of whether the chemical ionisation ion source is provided in combination together with the reagent or not, in the chemical ionisation ion source, the control unit is advantageously adapted to control the collector voltage source to apply the voltage difference between the photoelectron emittance surface and the collector electrode such that at least one of the current flowing through the photoelectron emittance surface and the current flowing through the collector electrode is less than 100 μA, in particular less than 10 μA, more particular less than 2 μA or even less than 0.5 μA. Particular advantageously, the control unit is adapted to control the collector voltage source to apply the voltage difference between the photoelectron emittance surface and the collector electrode such that both the current flowing through the photoelectron emittance surface and the current flowing through the collector electrode are less than 100 μA, in particular less than 10 μA, more particular less than 2 μA ore even less than 0.5 μA.

Correspondingly, in the chemical ionisation method, advantageously, at least one of the current flowing through the photoelectron emittance surface and the current flowing through the collector electrode is less than 100 μA, in particular less than 10 μA, more particular less than 2 μA or even less than 0.5 μA. Particular advantageously, both the current flowing through at the photoelectron emittance surface and the current flowing through the collector electrode are less than 100 μA, in particular less than 10 μA, more particular less 2 μA or even less than 0.5 μA.

Having both the current flowing through at the photoelectron emittance surface and the current flowing through the collector electrode being less than 100 μA, in particular less than 10 μA, more particular less than 2 μA or even less than 0.5 μA, has the advantage that a corona discharge ionisation as well a glow discharge ionisation are avoided in the irradiation chamber volume and in the reaction chamber volume. Thus, a self-sustaining ionisation in the irradiation chamber volume and in the reaction chamber volume is avoided and the ionisation can easily and very effectively be switched on and off by switching the electromagnetic radiation source on and off. This enables an optimal control of the chemical ionisation method and the chemical ionisation ion source. Furthermore, avoiding a corona discharge ionisation and a glow discharge ionisation in the irradiation chamber volume and in the reaction chamber volume has the advantage that a degradation of materials in the irradiation chamber and in the reaction chamber caused by discharge effects are avoided.

Independent of whether the current flowing through the photoelectron emittance surface, the current flowing through the collector electrode or both the current flowing through the photoelectron emittance surface and the current flowing through the collector electrode are less than 100 μA, in particular less than 10 μA, more particular less than 2 μA or even less than 0.5 μA, or not, the photoelectron emittance surface is advantageously arranged inside the irradiation chamber volume. In a first example, the photoelectron emittance surface is a surface of an element arranged inside the irradiation chamber volume. In a second example, the photoelectron emittance surface is a surface of a wall of the irradiation chamber confining the irradiation chamber volume and facing towards the irradiation chamber volume. In either example, in an advantageous variant, the photoelectron emittance surface is arranged inside the irradiation chamber volume opposite the chamber interface. Since the collector electrode is arranged in the reaction chamber in vicinity of the chamber interface, is arranged at the chamber interface or forms the chamber interface, the photoelectron emittance surface being arranged inside the irradiation chamber volume opposite the chamber interface has the advantage that photoelectrons emitted by the photoelectron emittance surface are driven towards the chamber interface into the space between the photoelectron emittance surface and the chamber interface. There, the photoelectrons can hit reagent molecules and/or reagent atoms, respectively, and ionise the reagent molecules and/or reagent atoms, respectively, to reagent ions, combine with reagent molecules and/or reagent atoms, respectively to reagent ions or can be driven further past the chamber interface into the reaction chamber volume. The photoelectron emittance surface can however as well be arranged inside the irradiation chamber volume but not opposite the chamber interface.

Advantageously, the photoelectron emittance surface is located at a distance of less than 20 mm, particular advantageous less than 15 mm, from the collector electrode. This has the advantage that for a given voltage difference between the photoelectron emittance surface and the collector electrode, a comparably high field strength between the photoelectron emittance surface and the collector electrode can be achieved.

Alternatively, however, the photoelectron emittance surface is located at a distance of 20 mm or more from the collector electrode.

Particular advantageous, the photoelectron emittance surface is a surface of a cone arranged inside the irradiation chamber volume, reaching with its tip into the irradiation chamber volume towards the chamber interface. This has the advantage that during operation of the chemical ionisation ion source, a high photoelectron density can be provided between the photoelectron emittance surface and the chamber interface in the vicinity of the chamber interface.

Alternatively, however, the photoelectron emittance surface is not a surface of a cone arranged inside the irradiation chamber volume.

Preferably, the volume of the irradiation chamber volume is more than 1 cm³, particular preferably more than 3 cm³, most preferably more than 7 cm³. Thereby, in an advantageous variant, the volume of the irradiation chamber volume is less than 20 cm³, in particular less than 10 cm³.

However, the volume of the irradiation chamber volume can as well be 20 cm³ or more or can be 1 cm³ or less.

Preferably, the volume of the reaction chamber volume is more than 10 cm³, particular preferably more than 20 cm³, most preferably more than 30 cm³. Thereby, in an advantageous variant, the volume of the irradiation chamber volume is less than 100 cm³, in particular less than 50 cm³.

However, the volume of the reaction chamber volume can as well be 100 cm³ or more or can be 10 cm³ or less.

Preferably, the reaction chamber volume has a length measured from the chamber interface to the outlet which is more than 2 cm, particular preferably more than 5 cm, most preferably more than 8 cm. Thereby, in an advantageous variant, the length of the reaction chamber volume measured from the chamber interface to the outlet is less than 25 cm, in particular less than 15 cm.

Alternatively, the length of the reaction chamber volume measured from the chamber interface to the outlet is 25 cm or more or 2 cm or less.

The chemical ionisation ion source advantageously includes an ion transfer arrangement adapted to transfer the analyte ions in the reaction chamber volume to the outlet. Particular advantageously, the ion transfer arrangement is further adapted to transfer the analyte ions through the outlet out of the reaction chamber volume. The ion transfer arrangement can however as well go without being adapted to transfer the analyte ions through the outlet out of the reaction chamber volume. In the latter case, the analyte ions may for example be transferred through the outlet out of the reaction chamber volume by a gas flow due to a gas pressure inside the reaction chamber volume being higher than a gas pressure on the outside of the outlet. In one example, this is the case if a mass analyser is arranged on the outside of the outlet for receiving the analyte ions, wherein the mass analyser is operated at a lower gas pressure than the gas pressure inside the reaction chamber volume. This can for example be the case if the chemical ionisation ion source is part of a mass spectrometer. In this case, the mass spectrometer includes advantageously the chemical ionisation ion source as well as the mass analyser for mass analysing the analyte ions.

Advantageously, the chemical ionisation method includes operating the ion transfer arrangement of the chemical ionisation ion source for transferring the analyte ions in the reaction chamber volume to the outlet of the reaction chamber for letting the analyte ions out of the reaction chamber volume. This can for example be achieved by applying a voltage to a transfer electrode of at least one transfer electrode of the ion transfer arrangement for generating an electric field.

The ion transfer arrangement can be arranged inside the reaction chamber volume, outside the reaction chamber volume or partially inside the reaction chamber volume and partially outside the reaction chamber volume. In the first case, the ion transfer arrangement is part of the reaction chamber. In the second and third case, the ion transfer arrangement can be part of the reaction chamber or can be separate from the reaction chamber.

Preferably, the ion transfer arrangement includes at least one transfer electrode for generating an electric field when a voltage is applied to the at least one transfer electrode. In an example, the at least one transfer electrode is a DC electrode for generating a static electric field along the reaction chamber volume for transferring the ions inside of the reaction chamber volume to the outlet and through the outlet out of the reaction chamber volume. Thereby, the DC electrode may be at the same time the collector electrode. In such a case, the collector electrode is one of the at least one transfer electrode of the ion transfer arrangement. In this example, the reaction chamber may for example be formed by an ion guide chamber as described in EP 1 968 100 A1 of Tofwerk AG. In this case, the ion guide chamber comprises a tube made of a resistive material, namely of doped lead silicate glass, wherein resistive regions of the two longitudinal ends of the tube are connected to the opposite poles of a DC voltage generating device such that a voltage is impressed on the tube, accelerating positive charges along the tube towards the outlet. Thereby, the longitudinal end of the tube opposite to the outlet may be formed by the collector electrode. In either of these two examples, the ion transfer arrangement may further include at least one confining electrode for applying an electric field for confining the ions in the reaction chamber volume when transferring the ions in the reaction chamber volume along the reaction chamber volume to the outlet. How this at least one confining electrode can be designed and operated is for example described i in paragraphs 43 and 44 of EP 1 968 100 A1 of Tofwerk AG. In this example, the confining electrodes are referred to as rod electrodes.

Alternatively, the chemical ionisation ion source may go without an ion transfer arrangement while the chemical ionisation method may go without operating such an ion transfer arrangement of the chemical ionisation ion source for transferring the analyte ions in the reaction chamber volume to an outlet of the reaction chamber for letting the analyte ions out of the reaction chamber volume.

Independent of whether such an ion transfer arrangement is present or part of the chemical ionisation ion source and of how such an ion transfer arrangement is designed, the electromagnetic radiation advantageously consists of photons having an energy in a range from 2 eV to 100 keV, particular advantageously from 2 eV to 200 eV. In case the electromagnetic radiation source is a green light source, the electromagnetic radiation consists of photons having an energy in a range from about 2.2 eV to about 2.5 eV. In case the electromagnetic radiation source is an x-ray source, the electromagnetic radiation consists of photons having an energy in a range from about 100 eV to about keV. In case the electromagnetic radiation is ultraviolet light, the ultraviolet light advantageously consists of photons having an energy in a range from 3 eV to 20 eV, particular advantageously in a range from 3 eV to 15 eV, most advantageously in a range from 4 eV to 11 eV.

Alternatively, however, the photons of the ultraviolet light may have an energy of less than 3 eV or of more then 20 eV. Even more, alternatively, the photons of the electromagnetic radiation may have an energy of less than 2 eV or of more than 100 keV.

Preferably, the electromagnetic radiation source is an ultraviolet light source for emitting ultraviolet light. Particular preferably, the ultraviolet light source includes vacuum ultraviolet (VUV) light source, in particular a noble gas lamp, for emitting ultraviolet light, in particular for illuminating the photoelectron emittance surface for emitting photoelectrons from the photoelectron emittance surface.

Vacuum ultraviolet light sources have the advantage that they enable providing photon intensities of the order of 10¹³ to 10¹⁵ photons per second. This enables the emittance of a good number of photoelectrons: Assuming an idealised case of a vacuum ultraviolet light source with a photon intensity of the order of 10¹³ whereof all photons are directed onto the photoelectron emittance surface and wherein each one of the photons causes the emittance of one photoelectron from the photoelectron emittance surface, 10¹³ photoelectrons per second are emitted. 10¹³ photoelectrons per second corresponds to a current of about 1.6 μA.

Examples of vacuum ultraviolet light sources are photoionisation Krypton lamps, electron-beam pumped Argon excimer light sources and Nd:YAG lasers with a ninth harmonic generation VUV-cell light source. A photoionisation Krypton lamp primarily emits photons in the vacuum ultra violet range at wavelengths of 124 nm and 117 nm, corresponding to photon energies of 10 eV and 10.6 eV, respectively. An electron-beam pumped Argon excimer light source emits photons in the vacuum ultra violet range at a wavelength of 126 nm, corresponding to a photon energy of 9.8 eV. An Nd:YAG laser with a ninth harmonic generation VUV-cell light source emits photons in the vacuum ultra violet range at a wavelength of 118 nm, corresponding to a photon energy of 10.5 eV.

Alternatively, the ultraviolet light may be provided by a different photon source than a vacuum ultraviolet (VUV) light source. Thus, the ultraviolet light source may include a photon source being different from a vacuum ultraviolet (VUV) light source for providing the ultraviolet light for illuminating the photoelectron emittance surface for emitting photoelectrons from the photoelectron emittance surface. For example, the ultraviolet light may be provided by an ultraviolet light emitting diode (UV-LED). In such a variant, the ultraviolet light source includes a UV-LED for providing the ultraviolet light for illuminating the photoelectron emittance surface for emitting photoelectrons from the photoelectron emittance surface.

In an alternative, the electromagnetic radiation source can differ from an ultraviolet light source. For example, the electromagnetic radiation source can be an x-ray radiation source for emitting x-ray radiation.

Independent of the type of electromagnetic radiation source used, advantageously, the chamber interface is adapted to fluidly couple the irradiation chamber volume to the reaction chamber volume for transferring the gaseous content of the irradiation chamber volume in a content transfer direction from the irradiation chamber volume to the reaction chamber volume, wherein the electromagnetic radiation source is advantageously arranged such that for illuminating the photoelectron emittance surface with the electromagnetic radiation for emitting photoelectrons from the photoelectron emittance surface, the electromagnetic radiation is directed onto the photoelectron emittance surface in an angle of more than 10°, more advantageously more than 45°, most advantageously essentially perpendicular, relative to the content transfer direction. This has the advantage that electromagnetic radiation can effectively be avoided to reach from the irradiation chamber volume into the reaction chamber volume. Thus, a photochemically induced rearrangement of the analyte can be avoided. Consequently, the chemical ionisation of the analyte to analyte ions is better defined.

Alternatively, however, the electromagnetic radiation source is arranged such that for illuminating the photoelectron emittance surface with the electromagnetic radiation for emitting photoelectrons from the photoelectron emittance surface, the electromagnetic raadiation is directed onto the photoelectron emittance surface in an angle of 10° or less relative to the content transfer direction.

In a first preferred variant, the chamber interface is made from a conductor, in particular from a metal. In this first variant, the collector electrode advantageously forms the chamber interface. This has the advantage that the chemical ionisation ion source can be constructed with less elements and can thus be constructed simpler. Nonetheless, the chamber interface can be made from a metal while the collector electrode is separate from the chamber interface.

In a second preferred variant, the chamber interface is made from an insulating material, like for example a ceramic. The chamber interface being made from an insulating material has the advantage that a higher voltage difference between the photoelectron emittance surface and the collector electrode can be applied without risking a corona discharge or a glow discharge between the photoelectron emittance surface and the collector electrode.

Alternatively to this first preferred variant and second preferred variant, the chamber interface is made from different materials than a conductor or an insulating material.

Advantageously, the chamber interface provides an opening having an aperture for coupling fluidly the irradiation chamber volume to the reaction chamber volume for transferring the gaseous content of the irradiation chamber volume, in particular gas, ions and electrons and thus reagent molecules and/or reagent atoms, respectively, reagent ions and electrons, from the irradiation chamber volume to the reaction chamber volume, wherein the aperture is in a range from 0.01 mm² to 5000 mm², particular advantageously in a range from 1 mm² to 100 mm².

Advantageously, the chamber interface provides on its side facing the irradiation chamber volume a funnel excavation leading from the irradiation chamber volume into the aperture of opening of the chamber interface) This has the advantage that transferring the gaseous content of the irradiation chamber volume from the irradiation chamber volume to the reaction chamber volume is more efficient. However, in an alternative, the chamber interface goes without such a funnel excavation.

Preferably, the chamber interface provides on its side facing the reaction chamber volume a cone reaching with its tip into the reaction chamber volume, wherein the opening having the aperture for coupling fluidly the irradiation chamber volume to the reaction chamber volume for transferring the gaseous content of the irradiation chamber volume from the irradiation chamber volume to the reaction chamber volume is located in the tip of this cone for introducing the gaseous content of the irradiation chamber volume into the reaction chamber volume.

Advantageously, the cone reaches with its tip from its base at least 2 mm, particular advantageously at least 4 mm, into the reaction chamber volume.

Independent of how deep the cone reaches with its tip into the reaction chamber volume, the collector electrode is advantageously arranged between the tip of the cone and the irradiation chamber volume. This has the advantage that a higher voltage difference between the photoelectron emittance surface and the collector electrode can be applied without risking a corona discharge or a glow discharge between the photoelectron emittance surface and the collector electrode. Thereby, particular advantageously, the cone is made from an insulating material, and most advantageously, the chamber interface is made from an insulating material.

Alternatively, the chamber interface goes without cone on its side facing the reaction chamber volume which cone reaches into the reaction chamber volume.

Advantageously, the sample inlet for inserting the sample into the reaction chamber volume is arranged between the chamber interface and the outlet.

In case the chamber interface provides on its side facing the reaction chamber volume a cone reaching with its tip into the reaction chamber volume, wherein the opening having the aperture for coupling fluidly the irradiation chamber volume to the reaction chamber volume for transferring the gaseous content of the irradiation chamber volume from the irradiation chamber volume to the reaction chamber volume is located in the tip of this cone for introducing the gaseous content of the irradiation chamber volume into the reaction chamber volume, the sample inlet for inserting the sample into the reaction chamber volume is arranged between the tip of this cone and the outlet. Thereby, particular advantageous, the sample inlet for inserting the sample into the reaction chamber volume is arranged between the tip of this cone and the outlet at a distance of less than 15 mm from the tip of the cone, in particular at a distance of less than 10 mm from the tip of the cone. However, the sample inlet for inserting the sample into the reaction chamber volume can as well be arranged between the tip of this cone and the outlet at a distance of 15 mm or more from the tip of the cone.

In an advantageous variant of where the chamber interface provides on its side facing the reaction chamber volume a cone reaching with its tip into the reaction chamber volume, the sample inlet is formed by the end of a sample tube reaching through the tip of the cone into the reaction chamber volume. In case in addition, the photoelectron emittance surface is a surface of a cone arranged inside the irradiation chamber volume, reaching with its tip into the irradiation chamber volume towards the chamber interface, then the sample inlet is advantageously formed by the end of a sample tube reaching through the tip of the cone arranged inside the irradiation chamber volume as well as through the tip of the cone into the reaction chamber volume.

As an alternative to these variants, however, the sample inlet for inserting the sample into the reaction chamber volume is not arranged between the chamber interface and the outlet. For example, the chamber interface may be arranged between the sample inlet and the outlet.

Advantageously, the reaction chamber provides a reaction chamber vacuum port for reducing a gas pressure in the reaction chamber volume as compared to atmospheric pressure. This has the advantage that the reaction chamber volume can efficiently be operated at a lower gas pressure than atmospheric pressure.

Advantageously, the reaction chamber vacuum port is connectable or connected to a vacuum pump or a built-in vacuum system in a building. Such built-in vacuum systems are often provided in laboratory buildings. There, vacuum ports are provided in the rooms of the laboratory building, the vacuum ports being connected to a vacuum pump in the building. In case the reaction chamber vacuum port is connectable or connected to a vacuum pump, the vacuum pump can be part of the chemical ionisation ion source or can be separate from the chemical ionisation ion source.

Instead of or in addition to the reaction chamber vacuum port, the irradiation chamber can provide an irradiation chamber vacuum port for reducing a gas pressure in the irradiation chamber volume as compared to atmospheric pressure, wherein advantageously, the irradiation chamber vacuum port is connectable or connected to a vacuum pump or a vacuum system as often provided in a laboratory building.

In case the irradiation chamber provides an irradiation chamber vacuum port for reducing the gas pressure in the irradiation chamber volume while the reaction chamber does not provide a reaction chamber vacuum port for reducing the gas pressure in the reaction chamber volume as compared to atmospheric pressure, the gas pressure in the reaction chamber volume can be reduced via the chamber interface through the irradiation chamber volume and the irradiation chamber vacuum port.

In case the reaction chamber provides a reaction chamber vacuum port for reducing the gas pressure in the reaction chamber volume while the irradiation chamber does not provide an irradiation chamber vacuum port for reducing the gas pressure in the irradiation chamber volume as compared to atmospheric pressure, the gas pressure in the irradiation chamber volume can be reduced via the chamber interface through the reaction chamber volume and the reaction chamber vacuum port. Nonetheless, independent of whether the irradiation chamber provides an irradiation chamber vacuum port for reducing the gas pressure in the irradiation chamber volume or not, the reaction chamber providing a reaction chamber vacuum port for reducing the gas pressure in the reaction chamber volume as compared to atmospheric pressure has the advantage that a flow of the gaseous content of the irradiation chamber volume through the chamber interface to the reaction chamber volume can be achieved by reducing the gas pressure in the reaction chamber volume via the reaction chamber vacuum port to a lower gas pressure than the gas pressure in the irradiation chamber volume. This causes a transfer of the gaseous content of the irradiation chamber volume, in particular gas, ions and electrons and thus reagent molecules and/or reagent atoms, respectively, reagent ions and electrons, like for example photoelectrons, from the irradiation chamber volume to the reaction chamber volume. In particular, such a flow of the gaseous content of the irradiation chamber volume from the irradiation chamber volume through the chamber interface to the reaction chamber volume can transfer positively charged reagent ions from the irradiation chamber volume through the chamber interface to the reaction chamber volume even though the voltage difference between the photoelectron emittance surface and the collector electrode is applied such that the potential of the collector electrode is higher than the potential of the photoelectron emittance surface in order to drive negative charges from the photoelectron emittance surface towards the collector electrode, resulting in positive charges and thus positively charged reagent ions being driven towards the photoelectron emittance surface.

Alternatively to these variants, the irradiation chamber goes without irradiation chamber vacuum port and the reaction chamber goes without reaction chamber vacuum port. In this case, the reaction chamber volume and the irradiation chamber volume can both be operated at a gas pressure reduced as compared to atmospheric pressure. In order to achieve this, for example, a reduced gas pressure can be maintained outside of the chemical ionisation ion source in front of the outlet. This can for example be the case where the chemical ionisation ion source is part of a mass spectrometer where after the outlet of the reaction chamber, an area of reduced gas pressure is provided.

Preferably, the chemical ionisation method includes reducing a gas pressure in the reaction chamber volume as compared to atmospheric pressure, particular advantageously via a reaction chamber vacuum port of the reaction chamber or via the outlet. Thus, particular advantageously, the reaction chamber provides a reaction chamber vacuum port and the reaction chamber vacuum port is connected to a vacuum pump or a built-in vacuum system of a building for reducing the gas pressure in the reaction chamber volume.

Instead of or in addition to reducing the gas pressure in the reaction chamber volume as compared to atmospheric pressure via the reaction chamber vacuum port of the reaction chamber or via the outlet of the reaction chamber, the chemical ionisation method advantageously includes reducing the gas pressure in the irradiation chamber volume as compared to atmospheric pressure via an irradiation chamber vacuum port of the irradiation chamber. In this case, the irradiation chamber vacuum port is advantageously connected to a vacuum pump or a built-in vacuum system of a building for reducing the gas pressure in the irradiation chamber volume.

Independent of whether the gas pressure in the irradiation chamber volume is reduced as compared to atmospheric pressure via the outlet or via an irradiation chamber vacuum port of the irradiation chamber or not, particular advantageously, the gas pressure in the reaction chamber volume is reduced via the outlet or the reaction chamber vacuum port to a lower gas pressure than the gas pressure in the irradiation chamber volume, causing a flow and thus transfer of the gaseous content of the irradiation chamber volume through the chamber interface to the reaction chamber volume. Such a flow has the advantage that positively charged reagent ions can be transferred via the chamber interface from the irradiation chamber vacuum volume to the reaction chamber volume by this flow even though the voltage difference between the photoelectron emittance surface and the collector electrode is applied such that the potential of the collector electrode is higher than the potential of the photoelectron emittance surface in order to drive negative charges from the photoelectron emittance surface towards the collector electrode, resulting in positive charges and thus positively charged reagent ions being driven towards the photoelectron emittance surface.

Advantageously, the irradiation chamber is adapted to be operated at a gas pressure in a range from 0.01 mbar to 100 mbar, particular advantageously in a range from 0.1 mbar to 10 mbar, most advantageously in a range from 1 mbar to 4 mbar, in the irradiation chamber volume. Advantageously, the reaction chamber is adapted to be operated at a gas pressure in a range from 0.01 mbar to 100 mbar, particular advantageously in a range from 0.1 mbar to 10 mbar, most advantageously in a range from 1 mbar to 4 mbar, in the reaction chamber volume.

Advantageously, in the chemical ionisation method, the irradiation chamber is operated at a gas pressure in the range from 0.01 mbar to 100 mbar, particular advantageously in the range from 0.1 mbar to 10 mbar, most advantageously in the range from 1 mbar to 4 mbar in the irradiation chamber volume. Advantageously, in the chemical ionisation method, the reaction chamber is operated at a gas pressure in the range from 0.01 mbar to 100 mbar, particular advantageously in the range from 0.1 mbar to 10 mbar, most advantageously in the range from 1 mbar to 4 mbar, in the reaction chamber volume.

Advantageously, the voltage difference between the photoelectron emittance surface and the collector electrode is between 100 V and 2000 V. In case the irradiation chamber volume and reaction chamber volume are operated at a pressure in a range from 1 mbar to 4 mbar, the voltage difference between the photoelectron emittance surface and the collector electrode is advantageously between 400 V and 1000 V. In case the irradiation chamber volume and reaction chamber volume are operated at a pressure of about 3 mbar, the voltage difference between the photoelectron emittance surface and the collector electrode is advantageously about 700 V.

In a variant, however, the voltage difference between the photoelectron emittance surface and the collector electrode is 100 V or less or 2000 V or more.

Alternatively to these variants however, the irradiation chamber is adapted to be operated at a gas pressure of 0.01 mbar or less or 100 mbar or more in the irradiation chamber volume, while in the chemical ionisation method, the irradiation chamber is operated at a gas pressure of 0.01 mbar or less or 100 mbar or more in the irradiation chamber volume. Furthermore, alternatively to the before mentioned variants, the reaction chamber is adapted to be operated at a gas pressure of 0.01 mbar or less or 100 mbar or more in the reaction chamber volume, while in the chemical ionisation method, the reaction chamber is operated at a gas pressure of 0.01 mbar or less or 100 mbar or more in the reaction chamber volume.

The chemical ionisation method advantageously includes maintaining the flow of the gaseous content of the irradiation chamber volume from the irradiation chamber volume through the chamber interface to the reaction chamber volume in a range from 0.1 sccm to 500 sccm, particular preferably from 1 sccm to 300 sccm, most preferably in a range from 5 sccm to 20 sccm.

This can for example be achieved by controlling at least one of a vacuum pump connected to said reaction chamber vacuum port for reducing the gas pressure in the reaction chamber volume as compared to atmospheric pressure, an irradiation chamber valve for controlling a flow of a gas into the irradiation chamber volume and a reaction chamber valve for controlling a flow of a gas into the reaction chamber volume to maintain the flow of the gaseous content of the irradiation chamber volume from the irradiation chamber volume through the chamber interface to the reaction chamber volume in a range from 0.1 sccm to 500 sccm, particular preferably from 1 sccm to 300 sccm, most preferably in a range from 5 sccm to 20 sccm. This can for example be achieved by having the control unit of the chemical ionisation ion source adapted to control at least one of the at least one of the vacuum pump, the irradiation chamber valve and the reaction chamber valve included in the chemical ionisation ion source for maintaining the flow of the gaseous content of the irradiation chamber volume from the irradiation chamber volume through the chamber interface to the reaction chamber volume in a range from 0.1 sccm to 500 sccm, particular preferably from 1 sccm to 300 sccm, most preferably in a range from 5 sccm to 20 sccm.

Accordingly, the chemical ionisation ion source advantageously includes at least one of a vacuum pump connected to the reaction chamber vacuum port for reducing the gas pressure in the reaction chamber volume as compared to atmospheric pressure, an irradiation chamber valve for controlling a flow of a gas into the irradiation chamber volume and a reaction chamber valve for controlling a flow of a gas into the reaction chamber volume. Thereby, the control unit is advantageously adapted to control at least one of the at least one of the vacuum pump, the irradiation chamber valve and the reaction chamber valve included in the chemical ionisation ion source for maintaining the flow of the gaseous content of the irradiation chamber volume from the irradiation chamber volume through the chamber interface to the reaction chamber volume in a range from 0.1 sccm to 500 sccm, particular preferably from 1 sccm to 300 sccm, most preferably in a range from 5 sccm to 20 sccm.

As an alternative to these variants, the flow of the gaseous content of the irradiation chamber volume from the irradiation chamber volume through the chamber interface to the reaction chamber volume can be maintained at 0.1 sccm or below or at 500 sccm or above. Even more, the chemical ionisation method may go without any control of the flow of the gaseous content of the irradiation chamber volume from the irradiation chamber volume through the chamber interface to the reaction chamber volume. Accordingly, the control unit may be adapted to control at least one of the at least one of the vacuum pump, the irradiation chamber valve and the reaction chamber valve included in the chemical ionisation ion source for maintaining the flow of the gaseous content of the irradiation chamber volume from the irradiation chamber volume through the chamber interface to the reaction chamber volume at 0.1 sccm or below or at 500 sccm or above, or the control unit may go without being adapted to control at least one of the at least one of the vacuum pump, the irradiation chamber valve and the reaction chamber valve included in the chemical ionisation ion source for maintaining the flow of the gaseous content of the irradiation chamber volume from the irradiation chamber volume through the chamber interface to the reaction chamber volume at particular values.

The chemical ionisation ion source is advantageously part of a mass spectrometer while the chemical ionisation method is advantageously part of a mass analysis method for mass analysing an analyte in a sample. Thus, a mass spectrometer advantageously includes the chemical ionisation ion source. Thereby, the mass spectrometer advantageously includes a mass analyser for mass analysing the analyte ions provided by the chemical ionisation ion method. This mass analyser is advantageously adapted to receive the analyte ions exiting from the outlet of the reaction chamber volume of the chemical ionisation ion source. Accordingly, a mass analysis method for mass analysing an analyte in a sample includes the chemical ionisation method. Thereby, the mass analysis method advantageously includes ionising an analyte in a sample to analyte ions and to mass analyse the analyte ions with a mass analyser.

Alternatively, however, the chemical ionisation ion source is not part of a mass spectrometer while the chemical ionisation method is employed separately from a mass analysis method.

Further advantageous embodiments and combinations of features of the invention result from the following exemplary embodiments and the set of patent claims as a whole.

### BRIEF DESCRIPTION OF THE DRAWINGS

The drawings used to illustrate the exemplary embodiments show:

FIG. 1 a simplified, schematic view of a mass spectrometer including a chemical ionisation ion source according to the invention and a mass analyser,

FIG. 2 a mass spectrum obtained with a mass spectrometer comprising the chemical ionisation ion source and the mass analyser shown in FIG. 1, when water vapour was used as reagent,

FIG. 3 a mass spectrum of a calibration gas mixture diluted in clean air obtained with the mass spectrometer comprising the chemical ionisation ion source and the mass analyser shown in FIG. 1 when using water vapour as reagent,

FIG. 4 a plot of the total ion signal versus time obtained with the mass spectrometer comprising the chemical ionisation ion source and the mass analyser shown in FIG. 1 in order to illustrate the effect of the DC voltage difference between the photoelectron emittance surface and the collector electrode on the efficiency of the chemical ionisation source, and

FIG. 5 a long term measurement during two weeks performed with the mass spectrometer comprising the chemical ionisation ion source and the mass analyser shown in FIG. 1 which illustrates the long term stability of the chemical ionisation ion source according to the invention and the chemical ionisation method according to the invention.

In general, identical parts are marked with the same reference symbols in the figures.

### WAYS TO CARRY OUT THE INVENTION

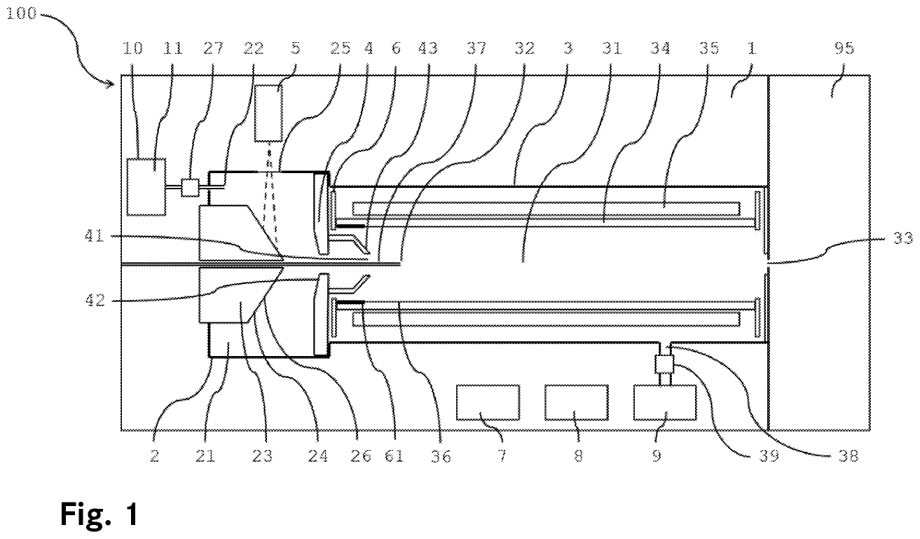

FIG. 1 shows a simplified, schematic view of mass spectrometer 100 including a chemical ionisation ion source 1 according to the invention and a mass analyser 95. With the chemical ionisation ion source 1, an analyte in a sample can be ionised with the chemical ionisation method according to the invention to analyte ions. The analyte ions are then transferred to the mass analyser 95, where they are mass analysed as known in the art. As data output, mass spectra are obtained as known in the art.

In a variant, the chemical ionisation ion source 1 is a separate unit and not part of a mass spectrometer.

In FIG. 1, the entire mass spectrometer 100 is shown. Thereby, the chemical ionisation ion source 1 is shown in a partially cross sectional view. Thus, the elements inside the chemical ionisation ion source 1 are visible. It is therefore visible that the chemical ionisation ion source 1 includes an irradiation chamber 2 and a reaction chamber 3. The irradiation chamber 2 forms an irradiation chamber volume 21 and has a reagent inlet 22 for inserting a reagent comprising reagent molecules and/or reagent atoms into the irradiation chamber volume 21. The reagent can for example be one of oxygen, water, ammonia, nitrogen, nitrogen monoxide, and argon. The irradiation chamber volume 21 has a volume of 8 cm³. The reaction chamber 3 on the other hand comprises a glass tube 34 which confines a reaction chamber volume 31. Thereby, the glass tube 34 is made from resistive material, namely of doped lead silicate glass. This reaction chamber volume 31 has a volume of 31 cm³ and a total length of 10 cm along a length of the glass tube 34. The reaction chamber 3 further has a sample inlet 32 for inserting the sample comprising the analyte into the reaction chamber volume 31 for ionising the analyte to the analyte ions in the reaction chamber volume 31 by bringing the analyte into contact with reagent ions being ionised reagent molecules and/or ionised reagent atoms, respectively. Furthermore, the reaction chamber 3 has an outlet 33 for letting the analyte ions out of the reaction chamber volume 31. This outlet 33 is arranged at an end of the glass tube 34. In the mass spectrometer 100, the mass analyser 95 is arranged downstream of the outlet 33 for receiving the analyte ions generated by the chemical ionisation ion source 1.

In order to transfer the analyte ions in the reaction chamber volume 31 to the outlet 33, the reaction chamber 3 and thus the chemical ionisation ion source 1 includes an ion transfer arrangement 36. This ion transfer arrangement 36 is adapted to transfer the analyte ions in the reaction chamber volume 31 to the outlet 33. The ion transfer arrangement 36 includes several confinement electrodes 35. These confinement electrodes 35 are arranged on the outside of the glass tube 34 and are distributed around the circumference of the glass tube 34. In operation of the chemical ionisation ion source 1, radio frequency AC voltages are applied to these confinement electrodes 35. These radio frequency AC voltages can be provided by any radio frequency AC voltage source which can be part of the chemical ionisation ion source 1 or can be separate from the chemical ionisation ion source 1. In one example, these radio frequency AC voltages are provided by the collector voltage source 7 described below. Independent of how the radio frequency AC voltage source is designed and independent of whether the collector voltage source 7 is at the same time the radio frequency AC voltage source or not, the radio frequency electromagnetic field resulting inside the glass tube 34 from the radio frequency AC voltages being applied to the confinement electrodes 35 drives positive and negative charges and thus the ions including the reagent ions and the analyte ions inside the reaction chamber volume 31 towards a center length axis of the glass tube 34 and thus towards a center length axis of the reaction chamber volume 31. Consequently, the analyte ions are confined by the confinement electrodes 35 to the center length axis of the reaction chamber volume 31.

The ion transfer arrangement 36 further includes one transfer electrode for pushing the analyte ions in the reaction chamber volume 31 to the outlet 33 and through the outlet 33 out of the reaction chamber volume 31. This one transfer electrode is arranged at the end of the glass tube 34 opposite to the end of the glass tube 34 where the outlet 33 is arranged. In order to push the positive analyte ions through the reaction chamber volume 31 and through the outlet 33 out of the reaction chamber volume 31, a positive voltage is applied to this one transfer electrode. In the chemical ionisation ion source 1 shown in FIG. 1, this one transfer electrode is at the same time the below described collector electrode 6 being in direct electrical contact with a resistive region 61 at longitudinal end of the glass tube 34 adjacent to the collector electrode 6. In variants, however, the transfer electrode is an electrode separate from the below described collector electrode 6. In a variant, the ion transfer arrangement 36 includes several transfer electrodes, like for example five or ten transfer electrodes, for pushing the analyte ions in the reaction chamber volume 31 to the outlet 33 and through the outlet 33 out of the reaction chamber volume 31. In this variant, these several transfer electrodes are arranged in a sequence along the glass tube 34. The first one of these transfer electrodes is the collector electrode 6 as shown in FIG. 1. Starting from this first one of these transfer electrodes, the further transfer electrodes are arranged one after the other towards in a sequence towards the outlet 33, where the last one of the transfer electrodes is arranged. In operation, to each one of these transfer electrodes another DC voltage is applied as known in the art to push the analyte ions in the reaction chamber volume 31 along the reaction chamber volume 31 to the outlet 33 and through the outlet 33 out of the reaction chamber volume 31.

In the present embodiment shown in FIG. 1, the glass tube 34 and the confinement electrodes 35 are designed as the glass tube and the four cylindrical rod electrodes described in EP 1 968 100 A1 of Tofwerk AG. Thereby, the collector electrode 6 is in contact with one of the resistive regions 61 of one of the two longitudinal ends of the glass tube 34, while the outlet 33 is arranged at the longitudinal end of the glass tube opposite to the collector electrode 6.

The ion transfer arrangement 36 can however as well be designed differently.

The chemical ionisation ion source 1 includes a photoelectron emittance electrode 23 having a photoelectron emittance surface 24. This photoelectron emittance surface 24 is located in the irradiation chamber 2 for emitting in the irradiation chamber volume 21 photoelectrons from the photoelectron emittance surface 24 when the photoelectron emittance surface 24 is irradiated with ultraviolet light.

In order to have the ultraviolet light at hand, the chemical ionisation ion source 1 also includes an ultraviolet light source 5 adapted to illuminate the photoelectron emittance surface 24 with ultraviolet light for emitting photoelectrons from the photoelectron emittance surface 24. This ultraviolet light source 5 includes a photoionisation Krypton lamp. A photoionisation Krypton lamp is vacuum ultraviolet (VUV) light source and provides ultraviolet light having photon energies of around 10 eV and 10.6 eV. The ultraviolet light source 5 is arranged outside of the irradiation chamber volume 21 but is part of the irradiation chamber 2. Thereby, the ultraviolet light source 5 is arranged in a volume adjacent to the irradiation chamber volume 21, wherein the two volumes are separated by a window 25 transparent for ultraviolet light. The ultraviolet light is directed from the ultraviolet light source 5 through the window 25 onto the photoelectron emittance surface 24 for emitting photoelectrons from the photoelectron emittance surface 24.

Thus, ultraviolet light source 5 adapted to illuminate the photoelectron emittance surface 24 with ultraviolet light for emitting photoelectrons from the photoelectron emittance surface 24 is an electromagnetic radiation source adapted to illuminate the photoelectron emittance surface with electromagnetic radiation for emitting photoelectrons from the photoelectrons form the photoelectron emittance source. In a variant, the chemical ionisation ion source 1 can include a different type of electromagnetic radiation source than the ultraviolet light source 5. For example, the electromagnetic radiation source can be an x-ray radiation source. In such an example, the x-ray radiation source is adapted to illuminate the photoelectron emittance surface with x-ray radiation for emitting photoelectrons from the photoelectron emittance surface.

Between the irradiation chamber 2 and the reaction chamber 3, the chemical ionisation ion source 1 includes a chamber interface 4 adapted to fluidly couple the irradiation chamber volume 21 to the reaction chamber volume 31 for transferring a gaseous content of the irradiation chamber volume 21 from the irradiation chamber volume 21 to the reaction chamber volume 31. In the variant shown in FIG. 1, the chamber interface 4 is made from a ceramic being an insulating material. In other variants however, the chamber interface can be made of another material and can even be made of a conductor like a metal.

The chamber interface 4 provides an opening 41 for coupling fluidly the irradiation chamber volume 21 to the reaction chamber volume 31 for transferring the gaseous content of the irradiation chamber volume 21, in particular gas, ions and electrons and thus reagent molecules and/or reagent atoms, respectively, reagent ions and electrons, from the irradiation chamber volume 21 to the reaction chamber volume 31. Thereby, the chamber interface 4 provides on its side facing the irradiation chamber volume 21 a funnel excavation 42 leading from the irradiation chamber volume 21 into the aperture of opening 41 of the chamber interface 4. Furthermore, the chamber interface 4 provides on its side facing the reaction chamber volume 31 a cone 43 reaching with its tip into the reaction chamber volume 31. Thereby, the opening 41 having the aperture for coupling fluidly the irradiation chamber volume 21 to the reaction chamber volume 31 for transferring the gaseous content of the irradiation chamber volume 21 from the irradiation chamber volume 21 to the reaction chamber volume 31 is located in the tip of this cone 43 for introducing the gaseous content of the irradiation chamber volume 21 into the reaction chamber volume 31.

With this arrangement, the chamber interface 4 is adapted to fluidly couple the irradiation chamber volume 21 to the reaction chamber volume 31 for transferring the gaseous content of the irradiation chamber volume 21 in a content transfer direction from the irradiation chamber volume 21 to the reaction chamber volume 31. Thereby, the ultraviolet light source 5 is arranged such that for illuminating the photoelectron emittance surface 24 with the ultraviolet light for emitting photoelectrons from the photoelectron emittance surface 24, the ultraviolet light is directed onto the photoelectron emittance surface 24 perpendicular relative to the content transfer direction. Thus, the ultraviolet light cannot to reach from the irradiation chamber volume 21 into the reaction chamber volume 31. Therefore a photochemically induced rearrangement of the analyte is avoided, leading to a better defined chemical ionisation of the analyte to analyte ions.

In the embodiment shown in FIG. 1, the chamber interface 4 forms a small chamber interface volume inside the cone 43. In a variant, the chamber interface 4 goes without such a small chamber interface volume. In yet another variant, the chamber interface 4 goes with a larger chamber interface volume. Independent of whether the chamber interface forms one or more chamber interface volumes or just provides one opening forming a passage, the chamber interface is adapted to fluidly couple the irradiation chamber volume 21 to the reaction chamber volume 31 for transferring the gaseous content of the irradiation chamber volume 21 in a content transfer direction from the irradiation chamber volume 21 to the reaction chamber volume 31.

In the embodiment shown in FIG. 1, the photoelectron emittance surface 24 is arranged inside the irradiation chamber volume 21 opposite the chamber interface 4. Thereby, the photoelectron emittance surface 24 is a surface of a cone 26 arranged inside the irradiation chamber volume 21, reaching with its tip into the irradiation chamber volume 21 towards the chamber interface 4. Since the collector electrode 6 is arranged in the reaction chamber 3 in vicinity of the chamber interface 4, the photoelectron emittance surface 24 being arranged inside the irradiation chamber volume 21 opposite the chamber interface 4 has the advantage that photoelectrons emitted by the photoelectron emittance surface 24 are driven towards the chamber interface 4 into the space between the photoelectron emittance surface 24 and the chamber interface 4. In a variant however, the photoelectron emittance surface 24 is arranged inside the irradiation chamber volume 21 but not opposite the chamber interface 4. In the variant shown in FIG. 1, the photoelectron emittance surface 24 is located at a distance of less than 15 mm from the collector electrode 6.

The sample inlet 32 for inserting the sample into the reaction chamber volume 31 is formed by the end of a sample tube 37 reaching through the tip of the cone 26 arranged inside the irradiation chamber volume 21 as well as through the tip of the cone 43 of the chamber interface 4 into the reaction chamber volume 41. Thereby, the sample inlet 32 for inserting the sample into the reaction chamber volume 31 is located inside the reaction chamber volume 31 between the tip of the cone 43 and the outlet 33 at a distance of about 10 mm from the tip of the cone 43.

Since the sample tube 37 reaches through the tip of the cone 43 of the chamber interface 4, the resulting aperture of the opening 41 of the chamber interface 4 which allows a flow of the gaseous content of the irradiation chamber volume 21 from the irradiation chamber volume 21 to the reaction chamber volume 31 is 3 mm². In variants, this aperture is bigger or smaller than the 3 mm². For example, the aperture is in a range from 1 mm² to 100 mm². In another example, the aperture is in a range from 0.01 mm² to 5000 mm².

As briefly mentioned, the chemical ionisation ion source 1 includes a collector electrode 6 which is at the same time one of the at least one transfer electrodes and thus is part of the ion transfer arrangement 36 as explained above. In the embodiment shown in FIG. 1, this collector electrode 6 is arranged in the reaction chamber 3 in vicinity of the chamber interface 4 and reaches partially into the reaction chamber volume 31. Thereby, the collector electrode 6 is located at the chamber interface 4. In variants to this particular embodiment, the collector electrode 6 is arranged at the chamber interface 4 or forms the chamber interface 4.

The chemical ionisation ion source 1 furthermore includes the above mentioned collector voltage source 7 and a control unit 8.

The collector voltage source 7 is connected to at least one of the photoelectron emittance surface 24 and the collector electrode 6 for applying a DC voltage difference between the photoelectron emittance surface 24 and the collector electrode 6 such that a potential of the collector electrode 6 is higher than a potential of the photoelectron emittance surface 24 in order to drive negative charges from the photoelectron emittance surface 24 towards the collector electrode 6. Thereby, the control unit 8 is adapted to control the collector voltage source 7 to apply the DC voltage difference between the photoelectron emittance surface 24 and the collector electrode 6 such that the potential of the collector electrode 6 is higher than the potential of the photoelectron emittance surface 24 in order to drive negative charges from the photoelectron emittance surface 24 towards the collector electrode 6. More precisely, in the embodiment shown in FIG. 1, the photoelectron emittance electrode 23 with the photoelectron emittance surface 24 is grounded and the collector voltage source 7 is connected to the collector electrode 6 for applying the DC voltage difference between the photoelectron emittance surface 24 and the collector electrode 6. In operation, the control unit 8 controls the collector voltage source 7 to apply a positive voltage to the collector electrode 6 in order to apply the DC voltage difference between the photoelectron emittance surface 24 and the collector electrode 6. Consequently, positively charged ions are repelled away from the collector electrode 6. In that the outlet 33 is arranged in the reaction chamber 3 opposite to the collector electrode 6, the positive voltage applied to the collector electrode 6 pushes positively charged analyte ions in the reaction chamber volume 31 away from the collector electrode 6 towards the outlet 33 for letting the positively charged analyte ions out of the reaction chamber volume 31. Even more, since the collector electrode 6 is arranged in the reaction chamber 3 in vicinity of the chamber interface 4, the positively charged analyte ions in the reaction chamber volume 31 are pushed by the positive voltage applied to the collector electrode 6 through the reaction chamber volume 31 to the outlet 33.

In operation of the chemical ionisation ion source 1, the DC voltage difference between the photoelectron emittance surface 24 and the collector electrode 6 is between 100 V and 2000 V, in particular between 400 V and 1000 V, or even about 700 V.

In the chemical ionisation ion source 1 shown in FIG. 1, the reaction chamber 3 provides a reaction chamber vacuum port 38 for reducing a gas pressure in the reaction chamber volume 31 as compared to atmospheric pressure. In operation of the chemical ionisation ion source 1, this reaction chamber vacuum port 38 is connected to a vacuum pump or a built-in vacuum system in a building. In one example, the chemical ionisation ion source 1 includes a vacuum pump 9 which is connected to the reaction chamber vacuum port 38. This vacuum pump 9 is controlled by the control unit 8 of the chemical ionisation ion source 1.

In operation of the chemical ionisation ion source 1, the gas pressure in the reaction chamber volume 31 is reduced with the vacuum pump 9 as compared to atmospheric pressure. Furthermore, through the reaction chamber vacuum port 38, the reaction chamber volume 31 and via the chamber interface 4, the gas pressure in the irradiation chamber volume 21 is as well reduced as compared to atmospheric pressure. Thereby, the irradiation chamber 2 and the reaction chamber 3 are both operated at a gas pressure in the range from 0.01 mbar to 100 mbar, in particular in the range from 0.1 mbar to 10 mbar, in the irradiation chamber 21 and the reaction chamber volume 31, respectively. Thereby, the vacuum pump 9 is controlled by the control unit 8 such that a flow of the gaseous content of the irradiation chamber volume 21 from the irradiation chamber volume 21 through the chamber interface 4 to the reaction chamber volume 31 is maintained in a range from 0.1 sccm to 500 sccm, particular preferably from 1 sccm to 300 sccm, or even in a range from 5 sccm to 20 sccm. In addition or alternatively to the reaction chamber vacuum port 38, the chemical ionisation ion source 1 can include an irradiation chamber valve 27 for controlling a flow of a gas into the irradiation chamber volume 21 and/or a reaction chamber valve 39 for controlling a flow of a gas into the reaction chamber volume 31. In such a variant, the control unit 8 is adapted to control at least one of the at least one of the vacuum pump 9, the irradiation chamber valve 27 and the reaction chamber valve 39 included in the chemical ionisation ion source 1 for maintaining the flow of the gaseous content of the irradiation chamber volume 21 from the irradiation chamber volume 21 through the chamber interface 4 to the reaction chamber volume 31 in a range from 0.1 sccm to 500 sccm, particular preferably from 1 sccm to 300 sccm, or even in a range from 5 sccm to 20 sccm. In the example of the irradiation chamber valve 27, the irradiation chamber valve 27 can be used to control the flow of the reagent through the reagent inlet 22 into the irradiation chamber volume 21. Having the irradiation chamber valve 27 controlling the flow of the reagent through the reagent inlet 22 into the irradiation chamber volume 21 enables to control the flow of the gaseous content of the irradiation chamber volume 21 from the irradiation chamber volume 21 through the chamber interface 4 to the reaction chamber volume 31 in case the gas pressure in the reaction chamber volume 31 is reduced either via the outlet 33 or via the reaction chamber vacuum port 38.

When executing the chemical ionisation method according to the invention for ionising an analyte in a sample by chemical ionisation to analyte ions with the chemical ionisation ion source 1, the reagent 11 comprising reagent molecules and/or reagent atoms is inserted through the reagent inlet 22 of the irradiation chamber 2 into the irradiation chamber volume 21. In order to provide a supply of the reagent 11, the chemical ionisation ion source 1 may comprise a reagent storage 10 with the reagent 11 or a separate reagent supply for supplying the reagent 11 may be provided. In either case, the chemical ionisation ion source 1 may itself go without reagent 11. However, for executing the chemical ionisation method, the chemical ionisation ion source 1 is combined with the reagent 11 to a combination of the chemical ionisation ion source 1 and the reagent 11.

When executing the chemical ionisation method with the chemical ionisation ion source 1, the photoelectron emittance surface 24 in the irradiation chamber volume 21 is irradiated with ultraviolet light from the ultraviolet light source 5 for emitting photoelectrons from the photoelectron emittance surface 24. Furthermore, with the collector voltage source 7, the DC voltage difference between the photoelectron emittance surface 24 and the collector electrode 6 is applied such that the potential of the collector electrode 6 is higher than the potential of the photoelectron emittance surface 24 in order to drive negative charges from the photoelectron emittance surface 24 towards the collector electrode 6. In order to achieve this, the collector voltage source 7 is controlled by the control unit 8 to apply the voltage difference between the photoelectron emittance surface 24 and the collector electrode 6.

Thereby, the photoelectron emittance surface 24 is grounded while a positive voltage is applied to the collector electrode 6. In particular, a positive voltage in a range between 100 V and 2000 V, in particular between 400 V and 1000 V, or even of about 700 V is applied to the collector electrode 6. Furthermore, the current flowing through the photoelectron emittance surface 24 and the current flowing through the collector electrode 6 is less than 100 μA or in a variant less than 10 μA or in another variant even less than 2 μA or in yet another variant even less than 0.5 μA. Accordingly, the control unit 8 is adapted to control the collector voltage source 7 to apply the voltage difference between the photoelectron emittance surface 24 and the collector electrode 6 such that the current flowing through the photoelectron emittance surface 24 and the current flowing through the collector electrode 6 is less than 100 μA, and in a variant less than 10 μA or in another variant even less than 2 μA or in yet another variant less than 0.5 μA.

Furthermore, when executing the chemical ionisation method, the sample comprising the analyte is inserted through the sample inlet 32 of the reaction chamber 2 into the reaction chamber volume 21 for ionising the analyte to the analyte ions in the reaction chamber volume 21. Additionally, the ion transfer arrangement 36 is operated in that the radio frequency AC voltages are applied to the confinement electrodes 35 as described above in order to confine the ions in the reaction chamber volume 31 to the center length axis of the reaction chamber volume 31 while the collector electrode 6 with the applied positive voltage is used as one of the at least one transfer electrodes of the ion transfer arrangement 36 to push the positive analyte ions through the reaction chamber volume 31 to the outlet 33 and out of the outlet 33. Thereby, in the mass spectrometer 100 of FIG. 1, the analyte ions exiting the outlet 33 are fed into the mass analyser 95 for being mass analysed. Thus, the chemical ionisation method according to the invention is employed in a mass analysis method for mass analysing an analyte in a sample.

When executing the chemical ionisation method, the vacuum pump 9 is controlled by control unit 8 to reduce the gas pressure in the reaction chamber volume 31 as compared to atmospheric pressure via the reaction chamber vacuum port 38 to which the vacuum pump 9 is connected. Thereby, through the reaction chamber vacuum port 38, the reaction chamber volume 31 and via the chamber interface 4, the gas pressure in the irradiation chamber volume 21 as well is reduced as compared to atmospheric pressure. Thereby, the irradiation chamber 2 and the reaction chamber 3 are both operated at a gas pressure in the range from 0.01 mbar to 100 mbar, in particular in the range from 0.1 mbar to 10 mbar, in the irradiation chamber 21 and the reaction chamber volume 31, respectively. As result, the flow of the gaseous content of the irradiation chamber volume 21 from the irradiation chamber volume 21 through the chamber interface 4 to the reaction chamber volume 31 is maintained in a range from 0.1 sccm to 500 sccm, particular preferably from 1 sccm to 300 sccm, or even in a range from 5 sccm to 20 sccm.

The chemical ionisation ion source 1 shown in FIG. 1 may as well include one or more heating unit for heating the irradiation chamber 2 and thus the irradiation chamber volume 21 and/or the reaction chamber 3 and thus the reaction chamber volume 31 to a specific temperature and for maintaining the irradiation chamber 2 and thus the irradiation chamber volume 21 and/or the reaction chamber 3 and thus the reaction chamber volume 31 at this specific temperature. Such a heating unit may be based on a resistive element. Thereby, one resistive element may for example be arranged in the irradiation chamber 2 around the irradiation chamber volume 21. Another resistive element may be arranged in the reaction chamber 3 around the reaction chamber volume 31. Such arrangements of heating units are known in the art of chemical ionisation ion sources and are used to generate the optimal temperature in the chemical ionisation ion source for having optimal operation conditions in the chemical ionisation ion source.

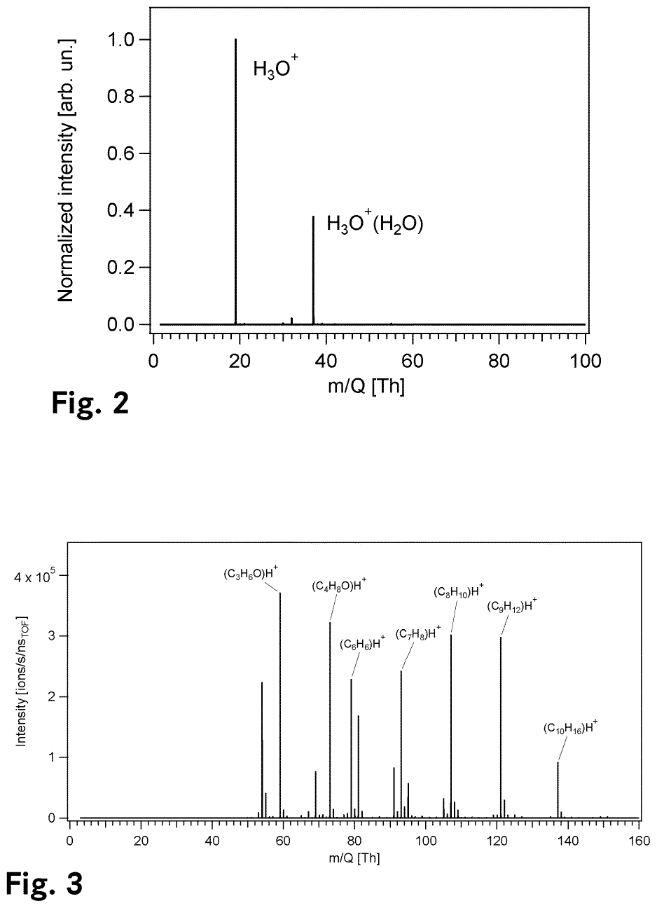

FIG. 2 shows a mass spectrum obtained with the mass spectrometer 100 comprising the chemical ionisation ion source 1 and the mass analyser 95 shown in FIG. 1. The mass spectrum was obtained when using water as the reagent 11, more particular when using water vapour as reagent gas. During the measurement for obtaining the mass spectrum of FIG. 2, clean air was introduced as sample through the sample inlet 32. The clean air was laboratory air from which all the volatile organic compounds (VOCs) have been removed by means of platinum catalyst trap. The total VOC concentration in this clean air was estimated to be below 10 ppb. The mass spectrum shown in FIG. 2 thus mainly shows the reagent ions H₃O⁺ and H₃O⁺(H₂O). The small peak at 32 Th is O₂⁺ introduced with the clean air as sample.

For obtaining the mass spectrum of FIG. 2, a positive DC voltage of 950 V was applied to the collector electrode 6 and a flow of 15 sccm water vapour was introduced as reagent 11 through the reagent inlet 22 into the irradiation chamber volume 21 and the ultraviolet light source 5 was switched on. Thereby, the gas pressure in the reaction chamber volume 31 was maintained constantly at 3 mbar. Thus, a constant flow of 15 sccm through the opening 41 of the chamber interface 4 from the irradiation chamber volume 21 to the reaction chamber volume 31 was maintained. As mentioned before, the aperture of the opening 41 of the chamber interface 4 which allows a flow of the gaseous content of the irradiation chamber volume 21 from the irradiation chamber volume 21 to the reaction chamber volume 31 was 3 mm². FIG. 2 illustrates how the chemical ionisation ion source 1 can be used with water vapour as reagent 11 in order to generate H₃O⁺ and H₃O⁺(H₂O) reagent ions that can be used for proton-transfer-reaction (PTR) mass spectrometry.

FIG. 3 shows another mass spectrum obtained with the mass spectrometer 100 comprising the chemical ionisation ion source 1 and the mass analyser 95 shown in FIG. 1. The mass spectrum was as well obtained when using water vapour as the reagent 11.

Thereby, a calibration gas mixture diluted in clean air to a concentration of 20 ppb for each compound was introduced as sample through the sample inlet 32 into the reaction chamber volume 31. This calibration gas mixture included acetone, 2-butanone, benzene, toluene, xylene, trimethylbenzene and α-pinene. The clean air was again laboratory air from which all the volatile organic compounds (VOCs) have been removed by means of platinum catalyst trap. The total VOC concentration in this clean air was estimated to be below 10 ppb.

For obtaining the mass spectrum of FIG. 3, a positive DC voltage of 850 V was applied to the collector electrode 6 and a flow of 20 sccm of water vapour was introduced as reagent 11 through the reagent inlet 22 into the irradiation chamber volume 21 and the ultraviolet light source 5 was switched on. Thereby, the gas pressure in the reaction chamber volume 31 was maintained constantly at 3.8 mbar. Thus, a constant flow of 20 sccm through the opening 41 of the chamber interface 4 from the irradiation chamber volume 21 to the reaction chamber volume 31 was maintained. As mentioned before, the aperture of the opening 41 of the chamber interface 4 which allows a flow of the gaseous content of the irradiation chamber volume 21 from the irradiation chamber volume 21 to the reaction chamber volume 31 was 3 mm².

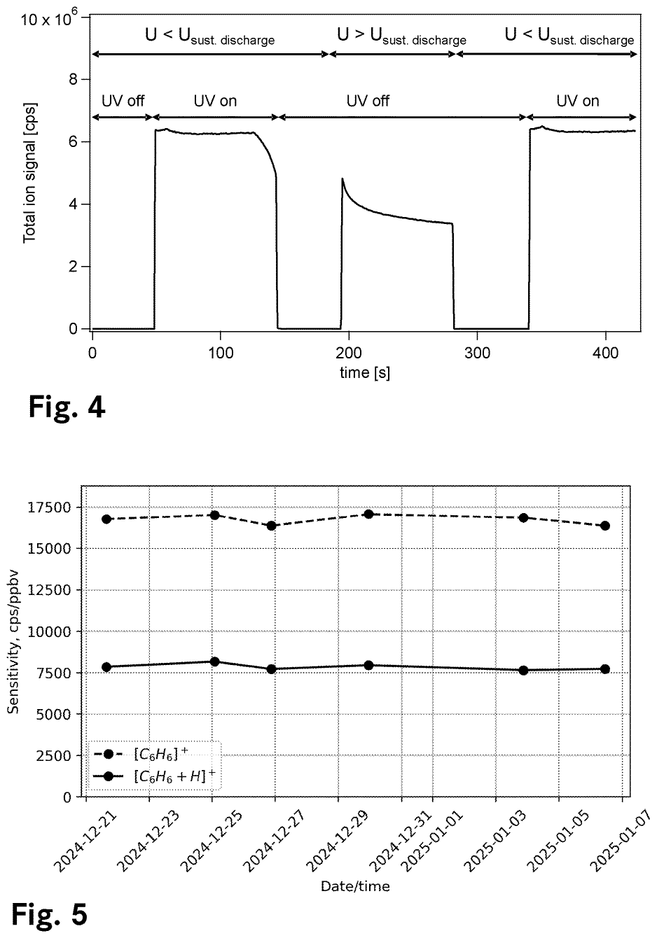

FIG. 4 shows a plot of the total ion signal versus time obtained with the mass spectrometer 100 comprising the chemical ionisation ion source 1 and the mass analyser 95 shown in FIG. 1.

FIG. 4 illustrates that the chemical ionisation ion source 1 is advantageously operated at a DC voltage applied to the collector electrode 6 which is below the threshold where a self-sustaining plasma occurs in one of or both the irradiation chamber volume 21 and the reaction chamber volume 31. In the same sense, for executing the method according to the invention, the DC voltage applied to the collector electrode 6 is advantageously below the threshold where a self-sustaining plasma occurs in one of or both the irradiation chamber volume 21 and the reaction chamber volume 31.

For obtaining the data shown in FIG. 4, a flow of 12 sccm water vapour was introduced as reagent 11 through the reagent inlet 22 into the irradiation chamber volume 21. Furthermore, clean air was introduced as sample through the sample inlet 32 into the reaction chamber volume 31. Again, the clean air was laboratory air from which all the volatile organic compounds (VOCs) have been removed by means of platinum catalyst trap. The total VOC concentration in this clean air was estimated to be below 10 ppb. The gas pressure in the reaction chamber volume 31 was maintained constantly at 1 mbar. Thus, a constant flow of 12 sccm through the opening 41 of the chamber interface 4 from the irradiation chamber volume 21 to the reaction chamber volume 31 was maintained. As mentioned before, the aperture of the opening 41 of the chamber interface 4 which allows a flow of the gaseous content of the irradiation chamber volume 21 from the irradiation chamber volume 21 to the reaction chamber volume 31 was 3 mm².

When obtaining the data shown in FIG. 4, initially, a positive DC voltage of 850 V was continuously applied to the collector electrode 6. After 45 seconds, the ultraviolet light source 5 was switched on such that the photoelectron emittance surface 24 was illuminated with ultraviolet light. With switching on the ultraviolet light source 5, the ion signal detected with the mass analyser 95 set in on a time scale of less than a second and remained essentially constant at more than 6×10⁶ counts per second during the 90 seconds the ultraviolet light source 5 remained switched on. During this period, the current flowing through the photoelectron emittance surface 24 was less or equal to 0.1 μA while the current flowing through the collector electrode 6 was 0.2 μA to 0.3 μA. With switching off the ultraviolet light source 5, the ion signal detected with the mass analyser 95 vanished within less than a second.

Eventually, in this regime with a positive DC voltage of 850 V applied to the collector electrode 6, an ultraviolet light driven photoelectron ionisation of the reagent molecules and/or reagent atoms, respectively, to reagent ions occurred in the chemical ionisation ion source 1. No self-sustaining plasma has been generated in the irradiation chamber volume 21 and/or the reaction chamber volume 31 when the DC voltage applied to the collector electrode 6 was 850 V.

In the same measurement, after 195 seconds from the start, the positive DC voltage applied to the collector electrode 6 was increased to 1′050 V while the ultraviolet light source 5 remained switched off. Within less than a second from increasing the positive DC voltage at the collector electrode 6, the ion signal at the mass analyser 95 set in again. However, this time, the intensity of the ion signal was only about 5×10⁶ counts per second, decaying sharply below 4×10⁶ counts per second within the subsequent seconds. After some 90 seconds after increasing the positive DC voltage applied to the collector electrode 6 to 1′050 V, the positive DC voltage applied to the collector electrode 6 was again reduced to 850 V. Within less than a second, the ion signal detected with the mass analyser 95 vanished again. Some 60 seconds later, the ultraviolet light source 5 was switched on again. As result, the ion signal detected with the mass analyser 95 set in again on a time scale of less than a second and remained again essentially constant at more than 6×10⁶ counts per second during the time the ultraviolet light source 5 remained switched on. During this period, again, the current flowing through the photoelectron emittance surface 24 was less or equal to 0.1 μA while the current flowing through the collector electrode 6 was 0.2 μA to 0.3 μA.

As becomes clear from FIG. 4, in the regime with the positive DC voltage of 1′050 V being applied to the collector electrode 6, a self-sustaining plasma was generated in the irradiation chamber volume 21 and/or the reaction chamber volume 31. In this regime, however, a not very high reagent ion production was achieved. Even more, this reagent ion production was not stable but decayed rapidly after having reached an initial maximum. In comparison, in the regime with the positive DC voltage of 850 V applied to the collector electrode 6 where ultraviolet light driven photoelectron ionisation is performed, the reagent ion production in the chemical ionisation ion source 1 was higher and considerably more stable. Thus, the chemical ionisation ion source 1 according to the invention and the chemical ionisation method according to the invention enable a surprisingly efficient and stable production of reagent ions available for chemical ionisation.

In view of this result, it is hypothesized by the inventors that when operating the chemical ionisation ion source 1, in the irradiation chamber volume 21, the photoelectrons hit reagent molecules and/or reagent atoms, respectively, and ionise the reagent molecules and/or reagent atoms, respectively, to reagent ions, combine with reagent molecules and/or reagent atoms, respectively, to reagent ions or are driven further past the chamber interface 4 into the reaction chamber volume 31, wherein in the latter case, in the reaction chamber volume 31, the photoelectrons hit reagent molecules and/or reagent atoms, respectively, and ionise the reagent molecules and/or reagent atoms, respectively, to reagent ions or combine with reagent molecules and/or reagent atoms, respectively, to reagent ions. Independent of the precise process, the inventors have observed that a surprisingly efficient and stable production of reagent ions is enabled, which reagent ions can be used in the reaction chamber volume 31 to react with the analyte of a sample to ionise the analyte to analyte ions.

FIG. 5 shows a long term measurement during two weeks which illustrates the long term stability of the chemical ionisation ion source according to the invention and the chemical ionisation method according to the invention. The data shown in FIG. 5 was obtained with the mass spectrometer 100 comprising the chemical ionisation ion source 1 and the mass analyser 95 shown in FIG. 1.

In this long term measurement, water vapour and oxygen were both used as reagent 11. Thereby, the reagent inlet 22 was coupled to two different reagent sources, one for providing the water vapour and the other for providing the oxygen. Thereby, every ten seconds, the reagent 11 was switched from one to the other. Thus, during ten seconds, water vapour was used as reagent 11, whereafter during ten seconds, oxygen was used as reagent 11. Thereafter, again water vapour was used as reagent 11, and so on. When water vapour was used as reagent 11, a flow of 14 sccm water vapour was introduced through the reagent inlet 22 into the irradiation chamber volume 21. When oxygen was used as reagent 11, a flow of 20 sccm water vapour was introduced through the reagent inlet 22 into the irradiation chamber volume 21. Each time, the reagent was switched, data collected during three seconds was discarded to purge the chemical ionisation ion source 1 and the mass analyser 95 with the newly used reagent. The data collected during the subsequent seven seconds was kept, until the reagent was switched the next time.

During the entire two weeks, the ultraviolet light source 5 was switched on and a positive DC voltage of 900 V was applied to the collector electrode 6, while the gas pressure in the reaction chamber volume 31 was maintained at about 3.5 mbar. As sample, ambient air was sampled into the chemical ionisation ion source 1 and analysed. In order to show the long term stability of the chemical ionisation ion source 1, every few days, sampling of the ambient air was interrupted for 10 to 30 minutes for calibrating the apparatus. During calibration, instead of the ambient air benzene (C₆H₆) diluted to 20 ppbv in clean air was introduced through the sample inlet 32 into the reaction chamber volume 31. During these calibration times, the reagent was as well switched every 10 seconds between water and oxygen as explained before.

The clean air for diluting the benzene during the calibration was laboratory air from which all the volatile organic compounds (VOCs) have been removed by means of platinum catalyst trap. The total VOC concentration of this clean air was estimated to be below 10 ppb. With this clean air, 1 ppmv calibration standard of benzene was diluted to 20 ppbv.

FIG. 5 shows the data points obtained for the benzene ionised with water and oxygen, respectively, measured with the mass analyser 95 during the calibration times. Thereby the data points are normalised to counts per second per ppbv (parts per billion by volume) benzene. As the data points remain stable at the same values over the two weeks measurement time, it becomes clear that the chemical ionization ion source according to the invention and the chemical ionization method according to the invention enable a surprisingly stable ionization of a sample even over long time periods.

In summary, it can be stated that a chemical ionisation ion source and a chemical ionisation method are provided for ionising an analyte in a sample by chemical ionisation to analyte ions which enable a more efficient and better defined chemical ionisation of the analyte to analyte ions.

### LIST OF REFERENCE SIGNS

1 chemical ionisation ion source
2 irradiation chamber
3 reaction chamber
4 chamber interface
5 ultraviolet light source
6 collector electrode
7 collector voltage source
8 control unit
9 vacuum pump
10 reagent storage
11 reagent
21 irradiation chamber volume
22 reagent inlet
23 photoelectron emittance electrode
24 photoelectron emittance surface
25 window
26 cone
27 irradiation chamber valve
31 reaction chamber volume
32 sample inlet
33 outlet
34 glass tube
35 confinement electrodes
36 ion transfer arrangement
37 sample tube
38 reaction chamber vacuum port
39 reaction chamber valve
41 opening
42 funnel excavation
43 cone
61 resistive region
95 mass analyser
100 mass spectrometer

1. A chemical ionisation ion source for ionising an analyte in a sample by chemical ionisation to analyte ions, the chemical ionisation ion source including:
a) an irradiation chamber forming an irradiation chamber volume and having a reagent inlet for inserting a reagent comprising reagent molecules and/or reagent atoms into said irradiation chamber volume;
b) a photoelectron emittance surface included in said irradiation chamber for emitting in said irradiation chamber volume photoelectrons from said photoelectron emittance surface when said photoelectron emittance surface is irradiated with electromagnetic radiation;
c) an electromagnetic radiation sourceadapted to illuminate said photoelectron emittance surface with electromagnetic radiation for emitting photoelectrons from said photoelectron emittance surface;
d) a reaction chamber confining a reaction chamber volume and having a sample inlet for inserting the sample comprising the analyte into said reaction chamber volume for ionising the analyte to the analyte ions in said reaction chamber volume by bringing the analyte into contact with reagent ions being ionised reagent molecules and/or reagent atoms, respectively, wherein said reaction chamber further has an outlet for letting the analyte ions out of said reaction chamber volume;
e) a chamber interface adapted to fluidly couple said irradiation chamber volume to said reaction chamber volume for transferring a gaseous content of said irradiation chamber volume from said irradiation chamber volume to said reaction chamber volume;
f) a collector electrode, wherein said collector electrode is arranged in said reaction chamber in vicinity of said chamber interface, is arranged at said chamber interface or forms said chamber interface;
g) a collector voltage source connected to at least one of said photoelectron emittance surface and said collector electrode and for applying a voltage difference between said photoelectron emittance surface and said collector electrode such that a potential of said collector electrode is higher than a potential of said photoelectron emittance surface in order to drive negative charges from said photoelectron emittance surface towards said collector electrode; and
h) a control unit adapted to control said collector voltage source to apply the voltage difference between said photoelectron emittance surface and said collector electrode such that the potential of said collector electrode is higher than the potential of said photoelectron emittance surface in order to drive negative charges from said photoelectron emittance surface towards said collector electrode.

2. The chemical ionisation ion source according to claim 1, wherein the voltage difference between the photoelectron emittance surface and the collector electrode is between 100 V and 2000 V.

3. The chemical ionisation ion source according to claim 1, wherein said control unit is adapted to control said collector voltage source to apply the voltage difference between said photoelectron emittance surface and said collector electrode such that at least one of the current flowing through said photoelectron emittance surface and the current flowing through said collector electrode is less than 100 μA.

4. The chemical ionisation ion source according to claim 1, wherein the chemical ionisation ion source includes an ion transfer arrangement adapted to transfer the analyte ions in said reaction chamber volume to said outlet.

5. The chemical ionisation ion source according to claim 1, wherein the electromagnetic radiation source is an ultraviolet light source including a vacuum ultraviolet (VUV) light source for emitting ultraviolet light.

6. The chemical ionisation ion source according to claim 1, wherein said chamber interface provides an opening having an aperture for coupling fluidly said irradiation chamber volume to said reaction chamber volume for transferring the gaseous content of said irradiation chamber volume from said irradiation chamber volume to said reaction chamber volume, wherein said aperture is in a range from 0.01 mm² to 5000 mm².

7. The chemical ionisation ion source according to claim 1, wherein said reaction chamber provides a reaction chamber vacuum port for reducing a gas pressure in said reaction chamber volume as compared to atmospheric pressure.

8. The chemical ionisation ion source according to claim 7, wherein the chemical ionisation ion source includes at least one of
a vacuum pump connected to said reaction chamber vacuum port for reducing the gas pressure in said reaction chamber volume as compared to atmospheric pressure,
an irradiation chamber valve for controlling a flow of a gas into the irradiation chamber volume and
a reaction chamber valve for controlling a flow of a gas into the reaction chamber volume,
wherein said control unit is adapted to control at least one of the at least one of the vacuum pump, the irradiation chamber valve and the reaction chamber valve included in the chemical ionisation ion source for maintaining the flow of the gaseous content of the irradiation chamber volume from the irradiation chamber volume through the chamber interface to the reaction chamber volume in a range from 0.1 sccm to 500 sccm.

9. A mass spectrometer including the chemical ionisation ion source according to claim 1.

10. A chemical ionisation method for ionising an analyte in a sample by chemical ionisation to analyte ions with a chemical ionisation ion source,
wherein the chemical ionisation method includes inserting a reagent comprising reagent molecules and/or reagent atoms through a reagent inlet of an irradiation chamber of the chemical ionisation ion source into an irradiation chamber volume of the irradiation chamber and irradiating a photoelectron emittance surface in the irradiation chamber volume with electromagnetic radiation from an electromagnetic radiation source, in particular ultraviolet light from an ultraviolet light source, of the chemical ionisation ion source for emitting photoelectrons from the photoelectron emittance surface,
wherein the chemical ionisation method includes applying with a collector voltage source of the chemical ionisation ion source a voltage difference between the photoelectron emittance surface and a collector electrode of the chemical ionisation ion source such that the potential of the collector electrode is higher than the potential of the photoelectron emittance surface in order to drive negative charges from the photoelectron emittance surface towards the collector electrode, wherein the chemical ionisation ion source provides a reaction chamber forming a reaction chamber volume, wherein the chemical ionisation ion source provides a chamber interface adapted to fluidly couple the irradiation chamber volume to the reaction chamber volume for transferring a gaseous content of the irradiation chamber volume from the irradiation chamber volume to the reaction chamber volume, wherein the collector electrode is arranged in the reaction chamber in vicinity of the chamber interface, is arranged at the chamber interface or forms the chamber interface, wherein the chemical ionisation method includes inserting the sample comprising the analyte through a sample inlet of the reaction chamber into the reaction chamber volume for ionising the analyte to the analyte ions in the reaction chamber volume.

11. The chemical ionisation method according to claim 10, wherein at least one of the current flowing through at the photoelectron emittance surface and the current flowing through the collector electrode is less than 100 μA.

12. The chemical ionisation method according to claim 10, wherein the chemical ionisation method includes operating an ion transfer arrangement of the chemical ionisation ion source for transferring the analyte ions in the reaction chamber volume to an outlet of the reaction chamber for letting the analyte ions out of the reaction chamber volume.

13. The chemical ionisation method according to claims 10, wherein chemical ionisation method includes reducing a gas pressure in the reaction chamber volume as compared to atmospheric pressure via the outlet or via a reaction chamber vacuum port of the reaction chamber.

14. The chemical ionisation method according to claim 10, wherein the chemical ionisation method includes maintaining the flow of the gaseous content of the irradiation chamber volume from the irradiation chamber volume through the chamber interface to the reaction chamber volume in a range from 0.1 sccm to 500 sccm.

15. The chemical ionisation ion source according to claim 1, wherein the electromagnetic radiation source is an ultraviolet light source.

16. The chemical ionisation ion source according to claim 1, wherein the electromagnetic radiation is ultraviolet light.

17. The chemical ionisation ion source according to claim 2, wherein the voltage difference between the photoelectron emittance surface and the collector electrode is between 400 V and 1000 V.

18. The chemical ionisation ion source according to claim 5, wherein the vacuum ultraviolet (VUV) light source is a noble gas lamp.

19. The chemical ionisation ion source according to claim 6, wherein said aperture is in a range from 1 mm² to 100 mm².

20. The chemical ionisation method according to claim 12, wherein the chemical ionisation method includes operating an ion transfer arrangement of the chemical ionisation ion source for transferring the analyte ions in the reaction chamber volume to an outlet of the reaction chamber for letting the analyte ions out of the reaction chamber volume by applying a voltage to an transfer electrode of at least one transfer electrode of the ion transfer arrangement for generating an electric field.
